(19) United States
(12) Patent Application Publication
(10) Pub. No.: US 2016/0279518 A1
(43) Pub. Date: Sep. 29, 2016

(54) INFORMATION STORAGE MEDIUM, TERMINAL, AND SERVER

(71) Applicant: BANDAI NAMCO Entertainment Inc., Tokyo (JP)

(72) Inventors: Masataka SHIMONO, Fujisawa-shi (JP); Naoyuki KISHIMOTO, Tokyo (JP)

(21) Appl. No.: 15/079,430

(22) Filed: Mar. 24, 2016

(30) Foreign Application Priority Data
Mar. 26, 2015 (JP) 2015-064999

(51) Int. Cl. A63F 13/537; A63F 13/35

(52) U.S. Cl. CPC A63F 13/537; A63F 13/35

(57) ABSTRACT

A terminal performs a process that places a plurality of objects and a special object that affects the progress of a game in a placement area, selection of an object among the plurality of objects being received based on input information input by the player, a process that generates the special effect of the special object, and a process that sets a game medium that has been selected based on the input information input by the player to a deck prior to start of the game. The terminal performs a process that reduces the special effect based on information about the game medium set to the deck.

Japanese Patent Application No. 2015-064999, filed on Mar. 26, 2015, is hereby incorporated by reference in its entirety.

### BACKGROUND OF THE INVENTION

The present invention relates to an information storage medium, a terminal, and a server.

A server system that provides the user with a community-type service referred to as “social networking service (SNS)” is known. Such a server system provides the user with an online game (social game) (see JP-A-2012-061060, for example).

Examples of the social game provided by such a server system include a puzzle game (“match 3 game”) in which the player places a predetermined number of objects (blocks or puzzle pieces) that have an identical feature in the vertical direction or the horizontal direction to delete the predetermined number of objects.

Such a puzzle game may be designed so that a special object that affects the progress of the game is placed in a placement area in addition to the object that can be selected by the player, and produces a special effect so that the player cannot easily delete the object.

However, the difficulty level of the game may increase to a large extent due to the production of the special effect, and the player may stop playing the game.

### SUMMARY

Several aspects of the invention may provide an information storage medium, a terminal, and a server that can motivate the player to play a game in which the player deletes an object.

According to a first aspect of the invention, there is provided a non-transitory computer-readable information storage medium storing a program that performs a process of causing a game to advance by receiving selection of an object among a plurality of objects placed in a placement area based on input information input by a player, changing a placement state of the selected object, and deleting the object that satisfies a predetermined condition, the program causing a computer to function as:

an object control section that places the objects and a special object that affects progress of a game in the placement area;

a special effect control section that performs a process that generates a special effect of the special object and a process that reduces (controls, decreases, prevents or limits) the special effect of the special object; and

a deck setting section that sets a game medium that has been selected based on the input information input by the player to a deck prior to start of the game,

wherein the special effect control section performs the process that reduces the special effect based on information about the game medium set to the deck.

According to a second aspect of the invention, there is provided a terminal that performs a process of causing a game to advance by receiving selection of an object among a plurality of objects placed in a placement area based on input information input by a player, changing a placement state of the selected object, and deleting the object that satisfies a predetermined condition, the terminal including:

an object control section that places the objects and a special object that affects progress of a game in the placement area;

a special effect control section that performs a process that generates a special effect of the special object and a process that reduces (controls, decreases, prevents or limits) the special effect of the special object; and

a deck setting section that sets a game medium that has been selected based on the input information input by the player to a deck prior to start of the game,

wherein the special effect control section performs the process that reduces the special effect based on information about the game medium set to the deck.

According to a third aspect of the invention, there is provided a server that performs a process of causing a game to advance by receiving selection of an object among a plurality of objects placed in a placement area based on input information input by a player, changing a placement state of the selected object, and deleting the object that satisfies a predetermined condition, the server including:

an object control section that places the objects and a special object that affects progress of a game in the placement area;

a special effect control section that performs a process that generates a special effect of the special object and a process that reduces (controls, decreases, prevents or limits) the special effect of the special object; and

a deck setting section that sets a game medium that has been selected based on the input information input by the player to a deck prior to start of the game,

wherein the special effect control section performs the process that reduces the special effect based on information about the game medium set to the deck.

### BRIEF DESCRIPTION OF THE SEVERAL VIEWS OF THE DRAWING

FIG. 1 illustrates a game system according to one embodiment of the invention.

FIG. 2 illustrates an example of a functional block diagram of a terminal according to one embodiment of the invention.

FIG. 3 illustrates an example of a functional block diagram of a server according to one embodiment of the invention.

FIG. 4 illustrates an example of a game screen.

FIGS. 5A and 5B illustrate game processes.

FIG. 6 is a table illustrating information about an object.

FIG. 7 is a table illustrating information about a special object.

FIGS. 8A and 8B illustrate game processes.

FIGS. 9A and 9B illustrate game processes.

FIGS. 10A and 10B illustrate game processes.

FIGS. 11A and 11B illustrate game processes.

FIGS. 12A and 12B illustrate game processes.

FIGS. 13A and 13B illustrate game processes.

FIGS. 14A and 14B illustrate game processes.

FIGS. 15A and 15B illustrate game processes.

FIG. 16 is a table illustrating information about a game medium (card).

FIG. 17 illustrates an example of a game screen.

FIG. 18 illustrates an example of a game screen.

FIG. 19 illustrates an example of a game screen.

FIGS. 20A and 20B illustrate a game screen and a game process.

FIGS. 21A and 21B illustrate a game screen and a game process.

FIGS. 22A and 22B illustrate a game screen and a game process.

FIGS. 23A and 23B illustrate a game screen and a game process.

FIGS. 24A and 24B illustrate a game screen and a game process.

FIGS. 25A to 25C illustrate examples of presentation information.

FIG. 26 is a flowchart illustrating the flow of a process.

### DETAILED DESCRIPTION OF THE EMBODIMENT

(1) According to one embodiment of the invention, there is provided a non-transitory computer-readable information storage medium storing a program that performs a process of causing a game to advance by receiving selection of an object among a plurality of objects placed in a placement area based on input information input by a player, changing a placement state of the selected object, and deleting the object that satisfies a predetermined condition, the program causing a computer to function as:

an object control section that places the objects and a special object that affects progress of a game in the placement area;

a special effect control section that performs a process that generates a special effect of the special object and a process that reduces the special effect of the special object; and

a deck setting section that sets a game medium that has been selected based on the input information input by the player to a deck prior to start of the game,

wherein the special effect control section performs the process that reduces the special effect based on information about the game medium set to the deck.

According to another embodiment of the invention, there is provided a terminal that performs a process of causing a game to advance by receiving selection of an object among a plurality of objects placed in a placement area based on input information input by a player, changing a placement state of the selected object, and deleting the object that satisfies a predetermined condition, the terminal including:

an object control section that places the objects and a special object that affects progress of a game in the placement area;

a special effect control section that performs a process that generates a special effect of the special object and a process that reduces the special effect of the special object; and

a deck setting section that sets a game medium that has been selected based on the input information input by the player to a deck prior to start of the game,

wherein the special effect control section performs the process that reduces the special effect based on information about the game medium set to the deck.

According to another embodiment of the invention, there is provided a server that performs a process of causing a game to advance by receiving selection of an object among a plurality of objects placed in a placement area based on input information input by a player, changing a placement state of the selected object, and deleting the object that satisfies a predetermined condition, the server including:

an object control section that places the objects and a special object that affects progress of a game in the placement area;

a special effect control section that performs a process that generates a special effect of the special object and a process that reduces the special effect of the special object; and

a deck setting section that sets a game medium that has been selected based on the input information input by the player to a deck prior to start of the game,

wherein the special effect control section performs the process that reduces the special effect based on information about the game medium set to the deck.

According to the above embodiments, since the special effect of the special object can be reduced based on the information about the game medium set to the deck, it is possible to motivate the player to play the game.

Note that the term “game medium” used herein refers to a card, a character, and the like.

(2) In each of the information storage medium, the terminal, and the server, the special effect control section may reduce the special effect of the special object placed within an area that corresponds to a set position of the game medium.

According to this configuration, since the special effect of the special object placed within an area that corresponds to a set position of the game medium is reduced, the set position of the game medium is important for obtaining the reduction effect. Specifically, the player can strategically play the game while taking account of the set position of the game medium.

(3) In the information storage medium, the program may cause the computer to further function as:

a game processing section that performs the process of causing the game to advance on a stage basis based on information about a shape of the placement area that corresponds to each stage, and information about the special object that is placed in the placement area; and

a display control section that displays at least one of the information about the shape of the placement area that corresponds to each stage, and the information about the special object that is placed in the placement area, as presentation information before the game medium is set to the deck.

Each of the terminal and the server may further include:

a game processing section that performs the process of causing the game to advance on a stage basis based on information about a shape of the placement area that corresponds to each stage, and information about the special object that is placed in the placement area; and

a display control section that displays at least one of the information about the shape of the placement area that corresponds to each stage, and the information about the special object that is placed in the placement area, as presentation information before the game medium is set to the deck.

According to this configuration, since at least one of the information about the shape of the placement area that corresponds to each stage, and the information about the special object that is placed in the placement area, is displayed as the presentation information before the game medium is set to the deck, the player can set a game medium that is optimum for obtaining the reduction effect in the deck at a position that is optimum for obtaining the control effect by checking the presentation information.

(4) In each of the information storage medium, the terminal, and the server, the game processing section may perform a process that counts a play count that corresponds to each stage, and determines whether or not a clear condition set to each stage has been satisfied, and the display control section may display the presentation information corresponding to a stage for which the play count is equal to or larger than a predetermined value, and the clear condition has not been satisfied.

According to this configuration, since the presentation information is displayed corresponding to a stage for which the play count is equal to or larger than a predetermined value, and the clear condition has not been satisfied, it is possible to prompt the player to play the game at least once without displaying the presentation information when the predetermined value is 1, for example. When the clear condition has not been satisfied by the first game play, it is possible to motivate the player to further play the game by displaying the presentation information as a hint.

(5) In each of the information storage medium, the terminal, and the server, the special effect control section may reduce the special effect when part of the objects placed within an area that corresponds to a set position of the game medium satisfies the predetermined condition.

According to this configuration, since the special effect is reduced when part of the objects placed within an area that corresponds to the set position of the game medium satisfies the predetermined condition, it is possible to prompt the player to perform an operation input so that the object placed within an area that corresponds to a set position of the game medium satisfies the predetermined condition. This makes it possible to improve game playability.

(6) In each of the information storage medium, the terminal, and the server, the special effect control section may reduce the special effect when an attribute of the game medium and an attribute of part of the objects that satisfies the predetermined condition have a predetermined relationship.

According to this configuration, since the special effect is reduced when the attribute (e.g., color) of the game medium and the attribute of the object that satisfies the predetermined condition have a predetermined relationship (e.g., are identical, or have a three-way standoff relationship), it is possible to prompt the player to perform an operation input so that the attribute of the game medium and the attribute of the object that satisfies the predetermined condition have a predetermined relationship. This makes it possible to improve game playability.

(7) In each of the information storage medium, the terminal, and the server, the special effect control section may reduce the special effect when the number of part of the objects that satisfy the predetermined condition is equal to or larger than a predetermined value.

According to this configuration, since the special effect is reduced when the number of objects that satisfy the predetermined condition is equal to or larger than a predetermined value, it is possible to prompt the player to perform an operation input so that the number of objects that satisfy the predetermined condition is equal to or larger than a predetermined value. This makes it possible to improve game playability.

(8) In the information storage medium, the program may cause the computer to further function as:

a game processing section that performs a process of determining whether or not a clear condition has been satisfied on a stage basis; and

a parameter control section that performs a process that changes a predetermined parameter of the game medium set to the deck when the clear condition has been satisfied, and

the special effect control section may change the degree of reduction of the special effect based on the predetermined parameter of the game medium set to the deck.

Each of the terminal and the server may further include:

a game processing section that performs a process of determining whether or not a clear condition has been satisfied on a stage basis; and

a parameter control section that performs a process that changes a predetermined parameter of the game medium set to the deck when the clear condition has been satisfied, and

the special effect control section may change the degree of reduction of the special effect based on the predetermined parameter of the game medium set to the deck.

According to this configuration, it is possible to enhance (strengthen) the game medium by changing a predetermined parameter of the game medium set to the deck (e.g., so as to be advantageous to the player) when the clear condition has been satisfied. Since the degree of reduction of the special effect is changed based on a predetermined parameter of the game medium set to the deck, it is possible to increase the degree of reduction of the special effect by further enhancing the game medium, for example. It is also possible to prompt the player to play the same stage or a stage with a low difficulty level in order to enhance the game medium.

Exemplary embodiments of the invention are described below. Note that the following exemplary embodiments do not unduly limit the scope of the invention as stated in the claims. Note also that all of the elements described below in connection with the following exemplary embodiments should not necessarily be taken as essential elements of the invention.

### 1. Game System

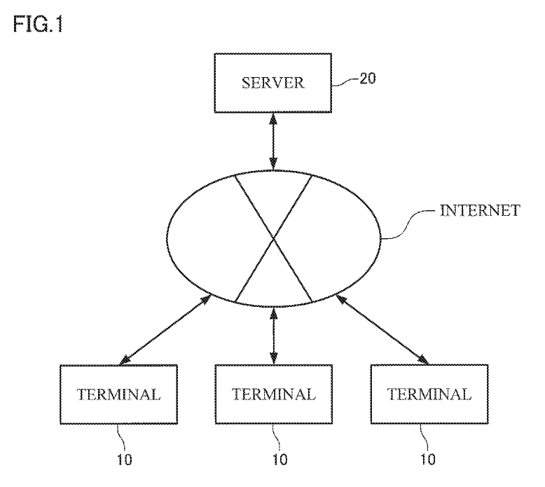

FIG. 1 illustrates a game system (network system or social network system) according to one embodiment of the invention. The game system includes a plurality of terminals 10 and a server 20 (server system). As illustrated in FIG. 1, the game system is configured so that the server 20 that provides a service and the terminals 10 can connect to a network (e.g., the Internet).

The server 20 is an information processing device that provides a service that allows a plurality of users (players) to communicate with each other. In this embodiment, the server 20 provides a community-type service that is referred to as “social networking service (SNS)”. Specifically, the server 20 transmits user information (e.g., user name, diary, notice information, and game field state) to a user who has logged in, as well as another user who maintains a friendship with the user who has logged in, so that these users can communicate with each other. The server 20 may provide the service to only users who have registered themselves as a member. The server 20 may be implemented by a single server, or may be implemented by a plurality of servers (e.g., authentication server, game processing server, communication server, accounting server, and database server).

The server 20 provides an online game service (social game) in response to a request from the terminal 10. In this embodiment, the terminal 10 executes a game program, and the server 20 manages account information about each player, information about the results of the game executed by the terminal 10, game media (e.g., card and character) that can be used in the game, an item that can be used in the game, and in-game money that can be used in the game, information about each stage of the game, and the like.

The terminal 10 is an information processing device such as a portable terminal (e.g., smartphone, mobile phone, or portable game machine), a personal computer (PC), a game device, or an image generation device, and can connect to the server 20 through a network (e.g., Internet (WAN) and LAN). Note that the terminal 10 and the server 20 may be connected through a cable communication channel, or may be connected through a wireless communication channel

### 2. Configuration

### 2.1 Configuration of Terminal

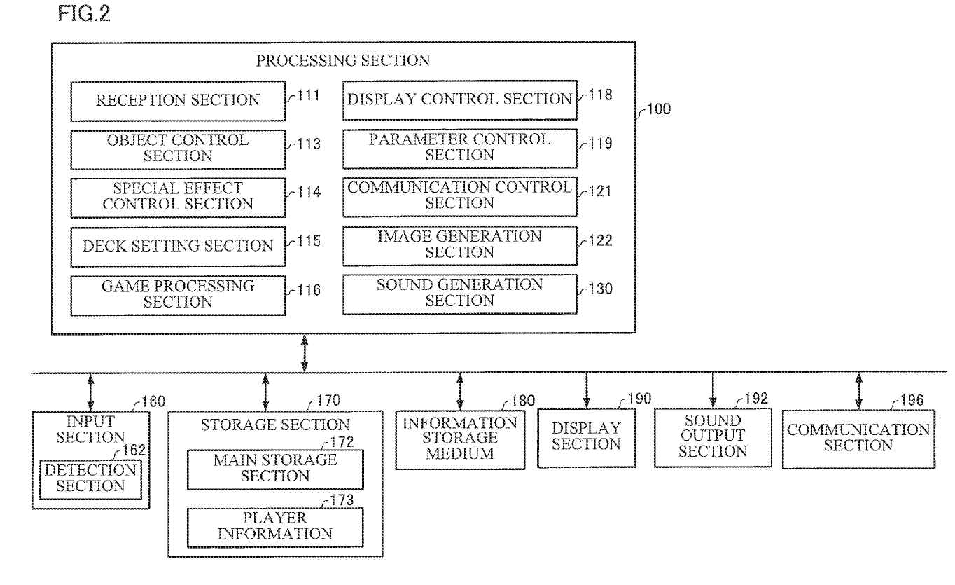

FIG. 2 illustrates an example of a functional block diagram of the terminal 10 (game device). Note that the terminal in this embodiment may have a configuration in which some of the elements (sections) illustrated in FIG. 2 are omitted.

An input section 160 is a device that allows the player to input information (input information), and detects the input information. The input section 160 outputs the input information (operation input) input by the player to a processing section 100. The function of the input section 160 may be implemented by an input device such as a touch panel, a touch pad, a mouse, a direction key, a button, or a keyboard. A detection section 162 detects a touch operation performed by the player from (on) a touch detection area (touch panel).

A storage section 170 stores a program that causes a computer to function as each section of the processing section 100, and various types of data, and serves as a work area for the processing section 100. The function of the storage section 170 may be implemented by a hard disk, a RAM, or the like. For example, the storage section 170 also stores information (e.g., parameter, attribute, and level) about a game medium (card or character) possessed by the player, information about an item possessed by the player, and information about in-game money and the like as player information 173. In this embodiment, the storage section 170 may store information (flag information) that represents whether or not the player possesses each game medium so as to be linked to each game medium. For example, the flag is set to 1 when the player possesses the game medium, and is set to 0 when the player does not possess the game medium. The storage section 170 may store information (flag information) that represents whether or not the player possesses each item so as to be linked to each item.

An information storage medium 180 (computer-readable medium) stores a program, data, and the like. The function of the information storage medium 180 may be implemented by an optical disk (CD or DVD), a magneto-optical disk (MO), a magnetic disk, a hard disk, a magnetic tape, a memory (ROM), or the like. Specifically, a program that causes a computer to function as each section in this embodiment (i.e., a program that causes a computer to execute the process of each section) is stored in the information storage medium 180.

A display section 190 outputs a game image generated by the processing section 100. The function of the display section 190 may be implemented by a display (e.g., touch panel display, LCD, or CRT).

A sound output section 192 outputs sound generated by the processing section 100. The function of the sound output section 192 may be implemented by a speaker, a headphone, or the like.

A communication section 196 performs various control processes for communicating with the server 20. The function of the communication section 196 may be implemented by hardware such as a processor or a communication ASIC, a program, or the like.

Note that the terminal 10 may receive a program and data that are stored in an information storage medium or a storage section included in the server 20 through a network, and store the received program and data in the storage section 170 or the information storage medium 180. A case where the terminal 10 receives a program and data that cause a computer to function as each section of the processing section 100 is also included within the scope of the invention.

The processing section 100 (processor) performs a game process, an image generation process, a sound generation process, and the like based on the input information (operation input) from the input section 160, the program and the data stored in the storage section 170 and the information storage medium 180, data received through the communication section 196, and the like. The processing section 100 performs various processes using a main storage section 172 included in the storage section 170 as a work area. The function of the processing section 100 may be implemented by hardware such as a processor (e.g., CPU or DSP) or an ASIC (e.g., gate array), or a program.

The processing section 100 includes a reception section 111, an object control section 113, a special effect control section 114, a deck setting section 115, a game processing section 116, a display control section 118, a parameter control section 119, a communication control section 121, an image generation section 122, and a sound generation section 130.

The reception section 111 performs a process that receives the input information from the input section 160.

The object control section 113 places an object for which selection can be received based on the input information input by the player, and a special object that affects the progress of the game in a placement area.

The special effect control section 114 performs a process that generates the special effect of the special object. The special effect control section 114 also performs a process that reduces the special effect based on the information about each game medium set to a deck.

For example, the special effect control section 114 may reduce the special effect of the special object placed within an area that corresponds to the set position of the game medium.

The special effect control section 114 may reduce the special effect when the object placed within an area that corresponds to the set position of the game medium satisfies a predetermined condition.

The special effect control section 114 may reduce the special effect when the attribute of the game medium and the attribute of the object that satisfies the predetermined condition have a predetermined relationship.

The special effect control section 114 may reduce the special effect when the number of objects that satisfy the predetermined condition is equal to or larger than a predetermined value.

The special effect control section 114 may change the degree of reduction of the special effect corresponding to a predetermined parameter of the game medium that has been set to the deck.

The deck setting section 115 sets the game medium that has been selected based on the input information input by the player to the deck prior to the start of the game.

The game processing section 116 performs a process of causing a game to advance by receiving the selection of the object placed in the placement area based on the input information input by the player, changing the placement state of the selected object, and deleting the object that satisfies the predetermined condition.

The game processing section 116 performs the process of causing the game to advance on a stage basis based on information about the shape of the placement area that corresponds to each stage, and information about the special object that is placed in the placement area.

The game processing section 116 may count the play count that corresponds to each stage. The game processing section 116 performs a process that determines whether or not a clear condition that corresponds to each stage has been satisfied.

The display control section 118 performs a control process that displays a game screen on the display section 190. For example, the display control section 118 performs a control process that displays a display object (e.g., object, special object, and game medium (card or character)).

For example, the display control section 118 may display at least one of the information about the shape of the placement area that corresponds to each stage, and the information about the special object that is placed in the placement area, as presentation information before the game medium is set to the deck. The display control section 118 may display the presentation information corresponding to a stage for which the play count is equal to or larger than a predetermined value, and the clear condition has not been satisfied.

The parameter control section 119 performs a process that changes a predetermined parameter of the game medium set to the deck when the clear condition that corresponds to the stage has been satisfied.

The communication control section 121 performs a process that exchanges data with the server 20 or another terminal 10 through a network. For example, the communication control section 121 may transmit information that notifies the server 20 of the start of the game when the game has started, and transmit game result information about the game result and various game parameters to the server 20 when the game has ended.

The communication control section 121 may transmit the information about the game medium possessed by the player, the information about the item possessed by the player, and the information about the in-game money and the like (that are stored in the storage section 170) to the server 20, for example.

When the information about the game medium possessed by the player, the information about the item possessed by the player, or the information about the in-game money has been changed (updated), the communication control section 121 may transmit the updated information to the server 20.

The image generation section 120 performs a drawing process based on the results of various processes performed by the processing section 100 to generate a game image, and outputs the generated game image to the display section 190. The image generation section 120 may generate an image (i.e., three-dimensional image) viewed from a virtual camera (given viewpoint) within an object space (game space).

The sound generation section 130 performs a sound generation process based on the results of various processes performed by the processing section 100 to generate a game sound (e.g., background music (BGM), effect sound, or voice sound), and outputs the generated game sound to the sound output section 192.

The processing section 100 may perform various processes based on the progress of the game (e.g., login count, game play count, time elapsed from the preceding login up to the current login, number of stages that have been cleared, or elapsed time).

### 2.2 Configuration of Server

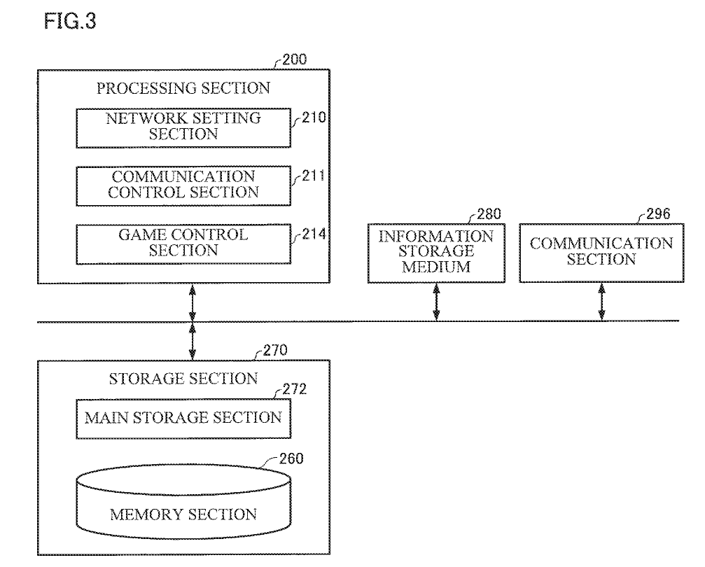

FIG. 3 illustrates an example of a functional block diagram of the server 20. Note that the server 20 may have a configuration in which some of the elements (sections) illustrated in FIG. 3 are omitted.

A storage section 270 serves as a work area for a processing section 200, a communication section 296, and the like. The function of the storage section 270 may be implemented by a RAM (VRAM) or the like. The storage section 270 includes a main storage section 272 and a memory section 260 (e.g., database).

The memory section 260 may store a login password of the player, an E-mail address (destination) of the player, accounting information, and the like so as to be linked to terminal identification information or player identification information (user account and user identification information) managed by the server 20.

An information storage medium 280 (computer-readable medium) stores a program, data, and the like. The function of the information storage medium 280 may be implemented by an optical disk (CD or DVD), a magneto-optical disk (MO), a magnetic disk, a hard disk, a magnetic tape, a memory (ROM), or the like. The processing section 200 performs various processes in this embodiment based on a program (data) stored in the information storage medium 280. Specifically, a program that causes a computer to function as each section in this embodiment (i.e., a program that causes a computer to execute the process of each section) is stored in the information storage medium 280.

The communication section 296 performs various control processes for communicating with the outside (e.g., terminal, another server, or another game system). The function of the communication section 296 may be implemented by hardware such as a processor or a communication ASIC, a program, or the like.

The processing section 200 (processor) performs various processes based on a program and data stored in the storage section 270 and the information storage medium 280, data received through the communication section 296, and the like. More specifically, the processing section 200 provides a service in response to a request from each terminal.

The processing section 200 performs various processes using the main storage section 272 included in the storage section 270 as a work area. The function of the processing section 200 may be implemented by hardware such as a processor (e.g., CPU or DSP) or an ASIC (e.g., gate array), or a program.

The processing section 200 included in the server 20 includes a network setting section 210, a communication control section 211, and a game control section 214. Note that the processing section 200 may have a configuration in which some of these sections are omitted.

The network setting section 210 receives the player identification information or the terminal identification information from the terminal 10, and stores network information about the player in the memory section 260 so as to be linked to the received player identification information or terminal identification information.

The communication control section 211 exchanges data with the terminal 10 through a network. Specifically, the communication control section 211 transmits information (requested by the terminal 10 of the player) to the terminal 10 based on a request from the terminal 10.

The game control section 214 performs various game control processes. For example, the game control section 214 receives the game result information transmitted from the game device (terminal 10), and performs an update process that updates various types of data linked to each player based on the game result information.

Note that the processing section 200 included in the server 20 may perform part or the entirety of the process performed by the processing section 100 included in the terminal 10.

The server 20 performs a process that receives the information about the game medium possessed by the player, the information about the item possessed by the player, and the information about the in-game money and the like from the terminal 10 as player information, and stores the player information in the storage section 270 (memory section 260) included in the server 20. Specifically, the server 20 performs a process that stores the information about the game medium possessed by the player, the information about the item possessed by the player, and the information about the in-game money and the like so as to be linked to the identification information about each player.

When the server 20 has received the information about the game medium possessed by the player, the information about the item possessed by the player, or the information about the in-game money and the like that has been changed (updated) from the terminal 10, the server 20 performs a process that updates the information stored in the storage section 270 (memory section 260) with the received information.

### 3. Method

### 3.1 Outline

The game according to one embodiment of the invention relates to a puzzle game in which the player places objects of a predetermined number or more (e.g., three or more) among a plurality of objects (e.g., objects A, B, C, and D) that have an identical attribute (e.g., identical color) so as to adjoin each other to delete the objects.

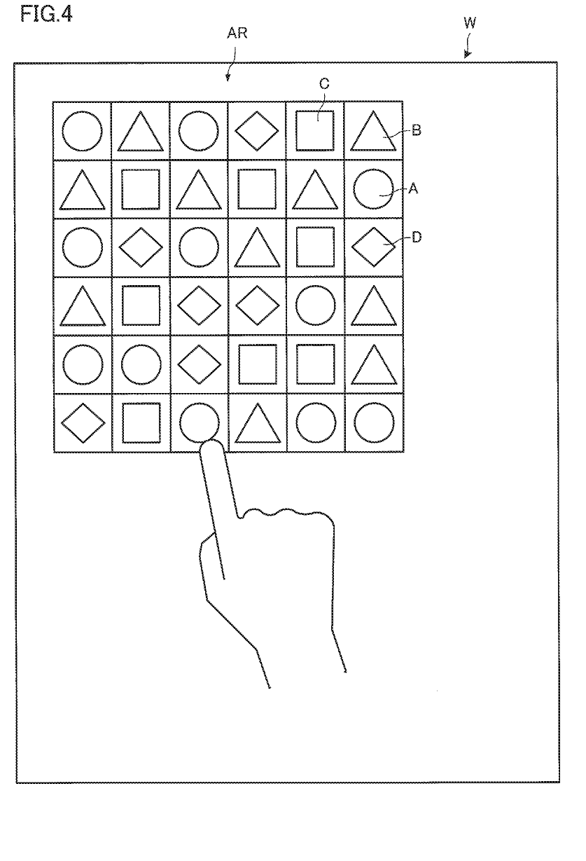

FIG. 4 illustrates an example of a game screen W (game image) that is generated according to this embodiment. The game screen W is displayed on the display section 190 (i.e., a display that includes a touch panel) of the terminal 10. The player can input information by performing a touch input (touch operation) that touches the touch panel with a fingertip, a touch pen, or the like.

As illustrated in FIG. 4, a placement area AR in which the objects A, B, C, and D are placed is provided within the game screen W in advance. Note that the objects A, B, C, and D are randomly selected and placed in the placement area AR when the game has started.

The player performs an input (e.g., touch input) that selects the desired object in the player's turn to change the placement state of the objects in the placement area AR. For example, the player interchanges two objects (selected objects) to change the placement state of the objects in the placement area AR. When a predetermined condition (object deletion condition or deletion condition) has been satisfied in the player's turn, a process that deletes the objects that satisfied the predetermined condition is performed. For example, the predetermined condition is a condition whereby three or more objects that have an identical attribute (identical color) have been placed consecutively in the vertical direction or the horizontal direction. Specifically, when three red objects have been placed consecutively in the horizontal direction, the three red objects are deleted from the placement area AR.

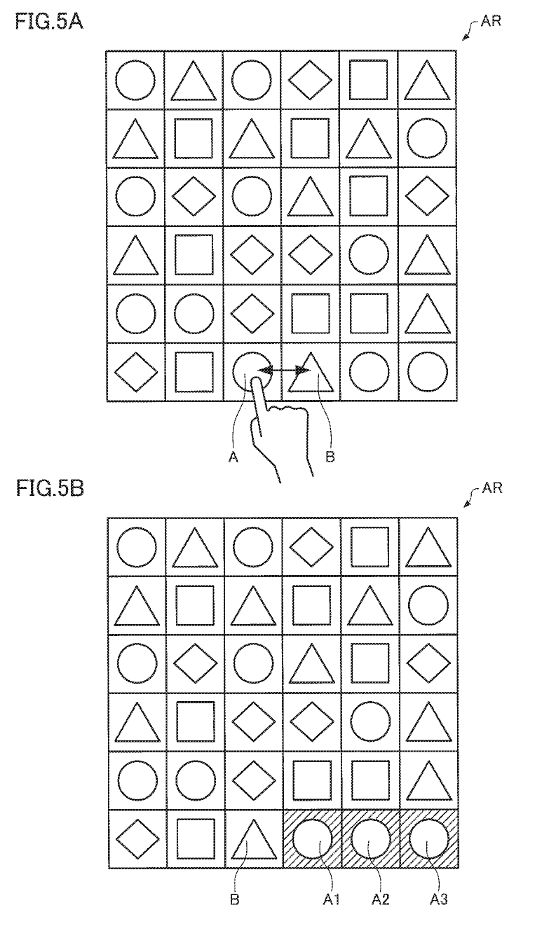

As illustrated in FIG. 5A, the player performs an information input (touch input, slide input, or flick input) that selects the desired object A and the object B that adjoins the desired object A, for example. When the player has performed a touch input that touches the object A that is situated in the lowermost row within the placement area AR, and performed a slide operation (touch input) that touches the object B that adjoins the object A, for example, the selection of the objects A and B is received.

When the selection of the objects A and B has been received, a process that interchanges the objects A and B is performed (i.e., the placement state is changed). As illustrated in FIG. 5B, three objects A1, A2, and A3 that have an identical attribute (identical color) are thus placed consecutively in the horizontal direction, and a process that deletes the objects A1, A2, and A3 from the placement area AR is performed. In this embodiment, when the three objects A1, A2, and A3 have been deleted, each object situated over the objects A1, A2, and A3 moves downward within the screen, and three objects are additionally placed in the uppermost row of the placement area AR. The attribute of each object that is additionally placed in the placement area AR is randomly determined.

In this embodiment, a plurality of stages are provided, and the difficulty level is increased along with the progress of the game. A different clear condition is set on a stage basis, and the player can play the next stage when the clear condition has been satisfied.

### 3.2 Object

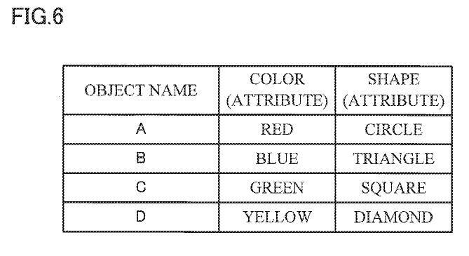

FIG. 6 illustrates an example of the objects stored in the storage section of the terminal or the server.

In this embodiment, a color (i.e., attribute) and a shape (i.e., attribute) are stored in the storage section so as to be linked to identification information (e.g., object name) about each object.

The object is selected based on information (input information) input by the player, and the selected object is set to be the deletion target.

The color is an example of the attribute, and represents the display color of each object. The shape is an example of the attribute, and represents the external shape of each object.

The color and the shape are used to determine whether or not the predetermined condition (deletion condition) is satisfied. For example, when three or more objects that have an identical color or an identical shape have been placed consecutively in the vertical direction or the horizontal direction, the three or more objects are deleted.

Note that the objects A to D are objects that are set to be the deletion target, and are normal objects that differ from special objects.

### 3.3 Special Object

In this embodiment, a process that places a special object that affects the progress of the game in the placement area AR, and causes the special object to produce a special effect, is performed.

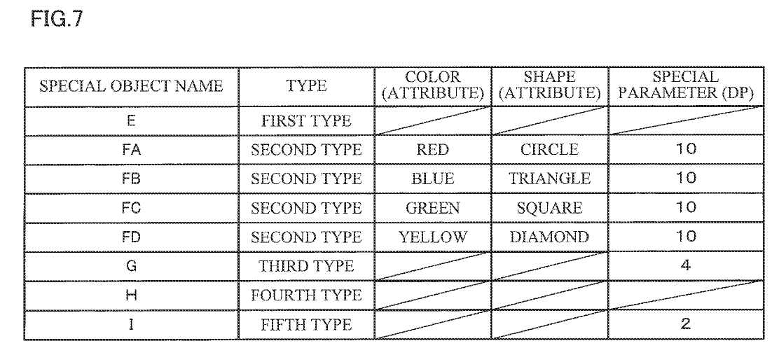

FIG. 7 illustrates an example of the special objects stored in the storage section of the terminal or the server.

In this embodiment, a type, a color (i.e., attribute), a shape (i.e., attribute), and a special parameter DP are stored in the storage section so as to be linked to identification information (e.g., special object name) about each special object.

The type represents the characteristics of the effect of each special object. The color is an example of the attribute, and represents the display color of each special object. The shape is an example of the attribute, and represents the external shape of each special object. The special parameter DP is a parameter regarding the special effect, and is linked to each special object. The initial value of the special parameter DP is set in advance. For example, the initial value of the special parameters DP of special objects FA to FD is set to 10, and the initial value of the special parameter DP of a special object G is set to 4. The initial value of the special parameter DP of a special object I is set to 2.

(1) Special Object that Belongs to First Type

A special object E that belongs to a first type is described below. The special object E is characterized in that (a) the player cannot select the special object E, (b) the special object E is deleted when the object A, B, C, or D placed in a square that adjoins the special object E has been deleted, and (c) an additional special object E is placed in a square that adjoins the special object E when the object A, B, C, or D placed in a square that adjoins the special object E has not been deleted.

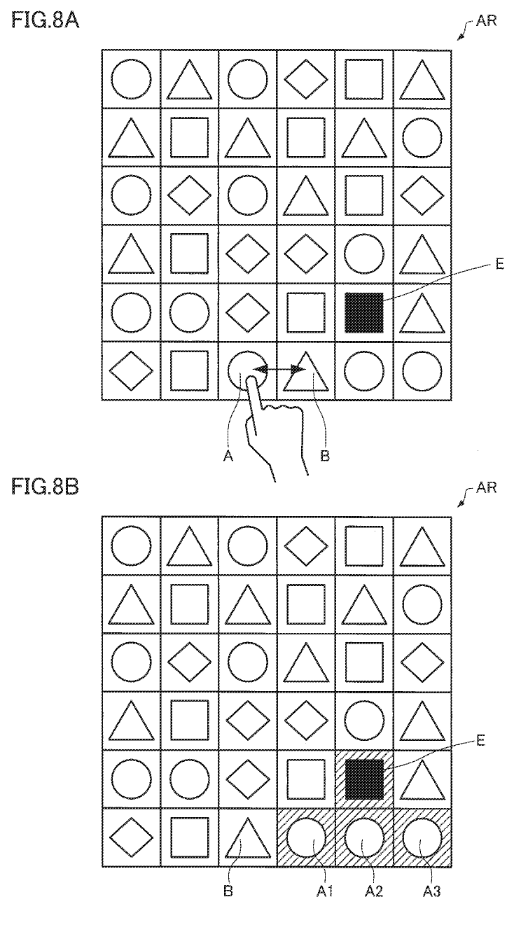

FIG. 8A illustrates an example in which the special object E is placed in the placement area AR in a fixed state. Note that the expression “in a fixed state” means that the special object E does not move within the placement area AR in the row direction and the column direction.

As illustrated in FIG. 8A, when the selection of the objects A and B that are placed in the lowermost row of the placement area AR has been received, the process that interchanges the objects A and B is performed (i.e., the placement state is changed).

As illustrated in FIG. 8B, three objects A1, A2, and A3 that have an identical attribute are thus placed consecutively in the horizontal direction, and the process that deletes the objects A1, A2, and A3 from the placement area AR is performed. Since the object A2 that adjoins the special object E is deleted, a process that deletes the special object E is performed.

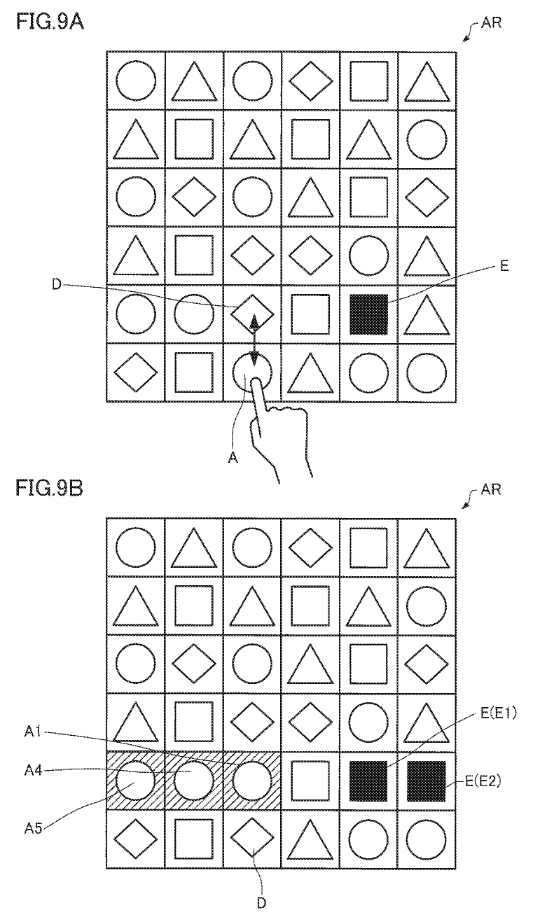

As illustrated in FIG. 9A, when the selection of the object A that is placed in the lowermost row of the placement area AR and the object D that is placed on the upper side of the object A and adjoins the object A has been received, the process that interchanges the objects A and D is performed (i.e., the placement state is changed).

As illustrated in FIG. 9B, three objects A1, A4, and A5 that have an identical attribute (identical color) are thus placed consecutively in the horizontal direction, and the process that deletes the objects A1, A4, and A5 from the placement area AR is performed. In this case, since the objects that are placed on the upper side, the lower side, the right side, or the left side of the special object E (E1) and adjoin the special object E (E1) are not deleted, a process that replaces an arbitrary object among the objects that are placed on the upper side, the lower side, the right side, or the left side of the special object E (E1) and adjoin the special object E (E1) with an additional special object E (E2) (i.e., a process that generates an additional special object E (E2)) is performed.

Specifically, since an additional special object E is placed when the object placed in a square that adjoins the special object E is not deleted, the player must perform a selection input so that the object placed in a square that adjoins the special object E is deleted.

(2) Special Object that Belongs to Second Type

The special objects FA to FD that belong to a second type are described below. The special object FA is characterized in that (a) a process that deletes an object group that includes the special object FA is performed when three or more objects including the special object FA that have an identical attribute have been placed consecutively, (b) the special parameter DP of the special object FA is decremented by 1 when the special object FA has not been deleted, and (c) the game is terminated when the special parameter DP of the special object FA has reached 0. Note that the special objects FB, FC, and FD that differ in attribute from the special object FA have the same features as those of the special object FA.

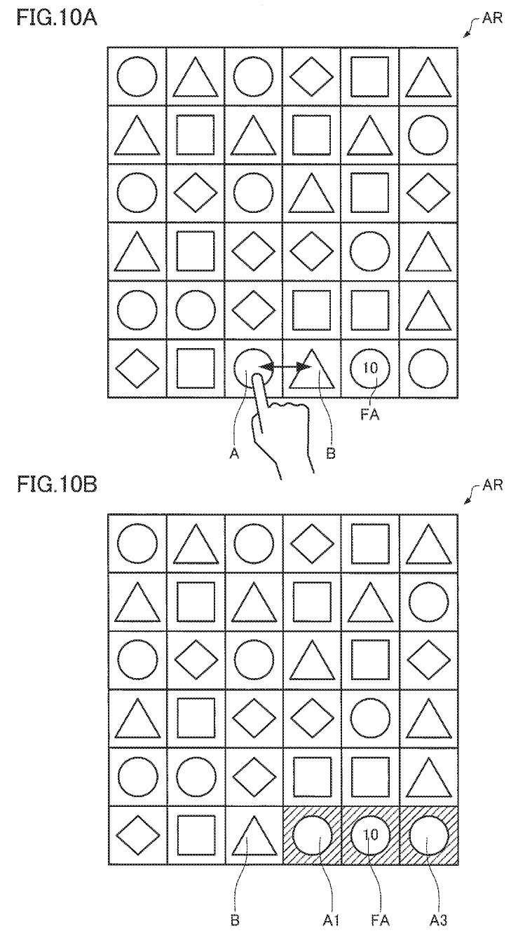

FIG. 10A illustrates an example in which the special object FA is placed in the lowermost row of the placement area AR. In this embodiment, the special parameter DP (e.g., 10) is displayed within the special object FA.

As illustrated in FIG. 10A, when the selection of the objects A and B that are placed in the lowermost row of the placement area AR has been received, the process that interchanges the objects A and B is performed (i.e., the placement state is changed).

As illustrated in FIG. 10B, three objects A1, FA, and A3 that have an identical attribute are thus placed consecutively in the horizontal direction, and the process that deletes the objects A1, FA, and A3 from the placement area AR is performed.

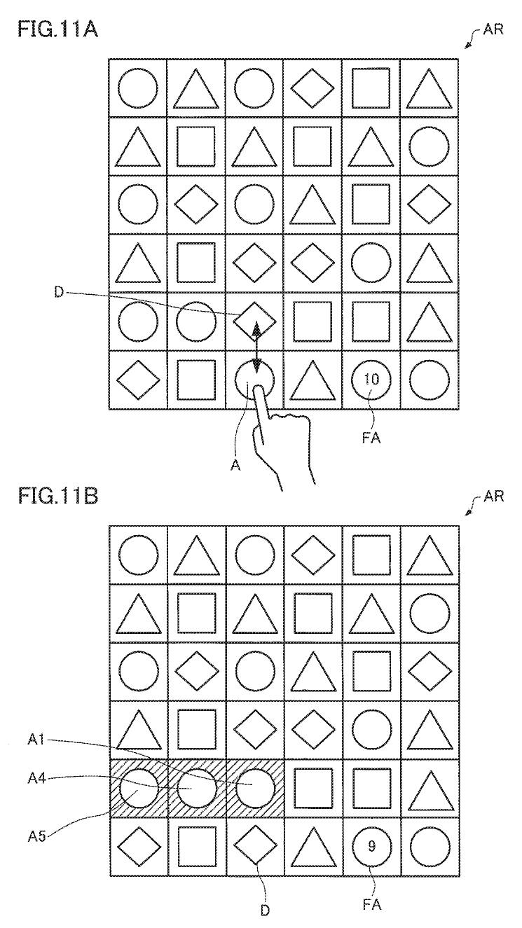

As illustrated in FIG. 11A, when the selection of the object A that is placed in the lowermost row of the placement area AR and the object D that is placed on the upper side of the object A and adjoins the object A has been received, the process that interchanges the objects A and D is performed (i.e., the placement state is changed).

As illustrated in FIG. 11B, three objects A1, A4, and A5 that have an identical attribute are thus placed consecutively in the horizontal direction, and the process that deletes the objects A1, A4, and A5 from the placement area AR is performed. In this case, since the special object FA is not deleted, the special parameter DP of the special object FA is decremented by 1. For example, the updated special parameter DP (e.g., 9) of the special object FA is displayed.

Specifically, the value of the special parameter DP corresponds to the number of turns in which the player can play the game. The player must delete the special object FA before the special parameter DP of the special object FA reaches 0 in order to prevent a situation in which the game is terminated.

(3) Special Object that Belongs to Third Type

The special object G is characterized in that (a) the player cannot select the special object G, (b) the special parameter DP of the special object G is decremented by 1 when the object A, B, C, or D placed in a square that adjoins the special object G has been deleted, and (c) the object (normal object) A, B, C, or D can be placed in the square in which the special object G has been placed when the special parameter DP of the special object G has reached 0.

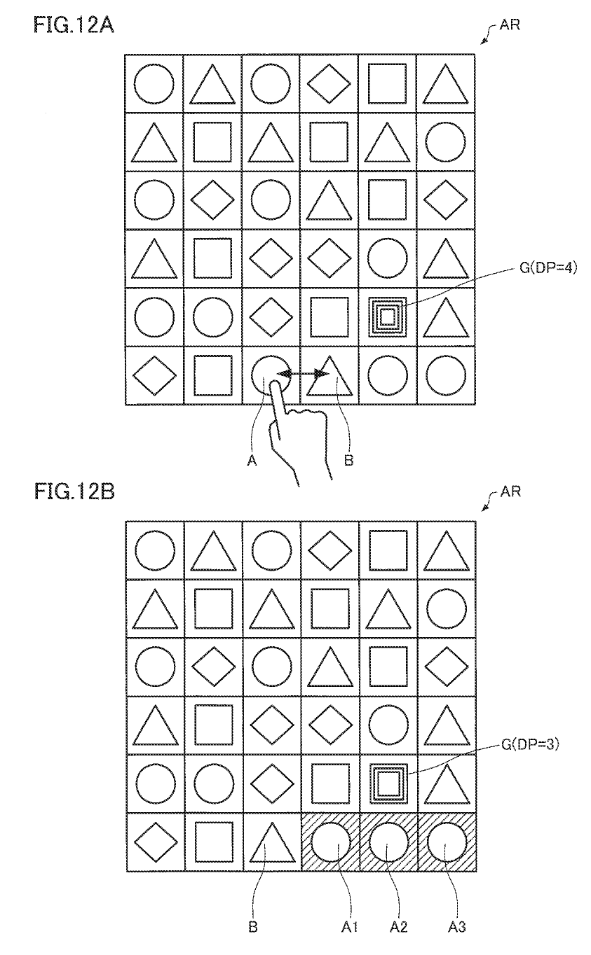

FIG. 12A illustrates an example in which the special object G (DP=4) is placed in the placement area AR in a fixed state. In this embodiment, the display pattern of the special object G is changed based on the value of the special parameter DP of the special object G. For example, the special object G is displayed using four concentric squares when DP=4, displayed using three concentric squares when DP=3, displayed using two concentric squares when DP=2, and displayed using one square when DP=1. When DP=1, the special object G is displayed to have a color or a pattern that differs from that of the object C so that the special object G can be distinguished from the object C (since the special object G and the object C have an identical shape).

As illustrated in FIG. 12A, when the selection of the objects A and B that are placed in the lowermost row of the placement area AR has been received, the process that interchanges the objects A and B is performed (i.e., the placement state is changed).

As illustrated in FIG. 12B, three objects A1, A2, and A3 that have an identical attribute (identical color) are thus placed consecutively in the horizontal direction, and the process that deletes the objects A1, A2, and A3 from the placement area AR is performed. Since the object A2 that adjoins the special object G is deleted, a process that decrements the value of the special parameter DP of the special object G by 1 is performed. The special object G is deleted when the value of the special parameter DP of the special object G has reached a predetermined value (0). In the example illustrated in FIG. 12B, since the value of the special parameter DP of the special object G is 3, the special object G is allowed to remain (is continuously displayed). When the value of the special parameter DP of the special object G has reached a predetermined value (0), and the special object G has been deleted, the object (normal object) A, B, C, or D is placed in the square in which the special object G was placed.

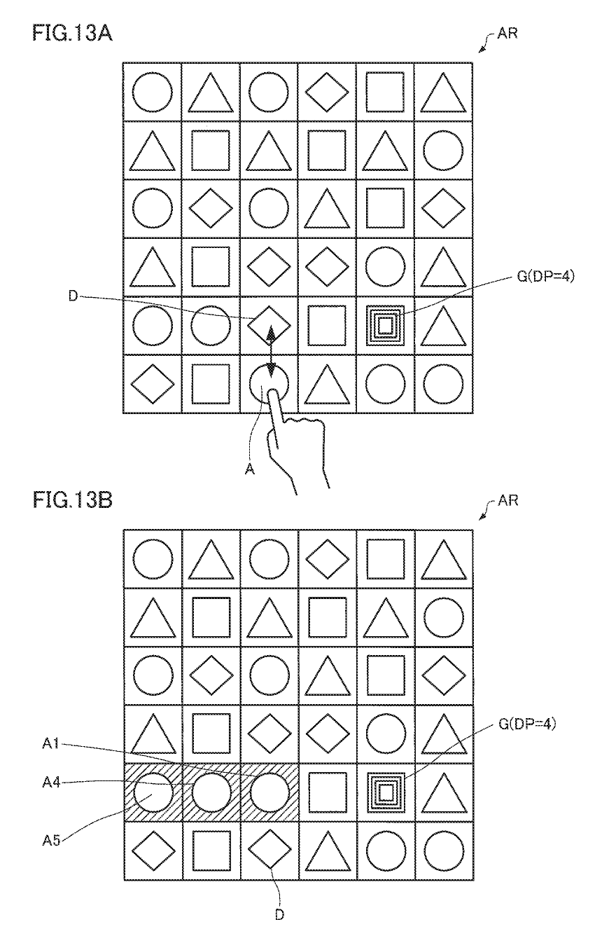

As illustrated in FIG. 13A, when the selection of the object A that is placed in the lowermost row of the placement area AR and the object D that is placed on the upper side of the object A and adjoins the object A has been received, the process that interchanges the objects A and D is performed (i.e., the placement state is changed).

As illustrated in FIG. 13B, three objects A1, A4, and A5 that have an identical attribute (identical color) are thus placed consecutively in the horizontal direction, and the process that deletes the objects A1, A4, and A5 from the placement area AR is performed. Since the objects that adjoin the special object G are not deleted, the value of the special parameter DP of the special object G is not decremented by 1 (DP=4).

For example, when the stage clear condition is a condition whereby all of the special objects G have been deleted, or when the objects (normal objects) A to D are placed by deleting the special object G to delete the normal objects, the player must steadily delete the object placed in a square that adjoins the special object G so that the special parameter DP of the special object G reaches 0.

(4) Special Object that Belongs to Fourth Type

The special object H that belongs to a fourth type is described below. The special object H is characterized in that (a) the player cannot select the special object H, (b) the special object E is generated when the object A, B, C, or D is placed in a square that adjoins the special object H, and (c) the special object H is not deleted.

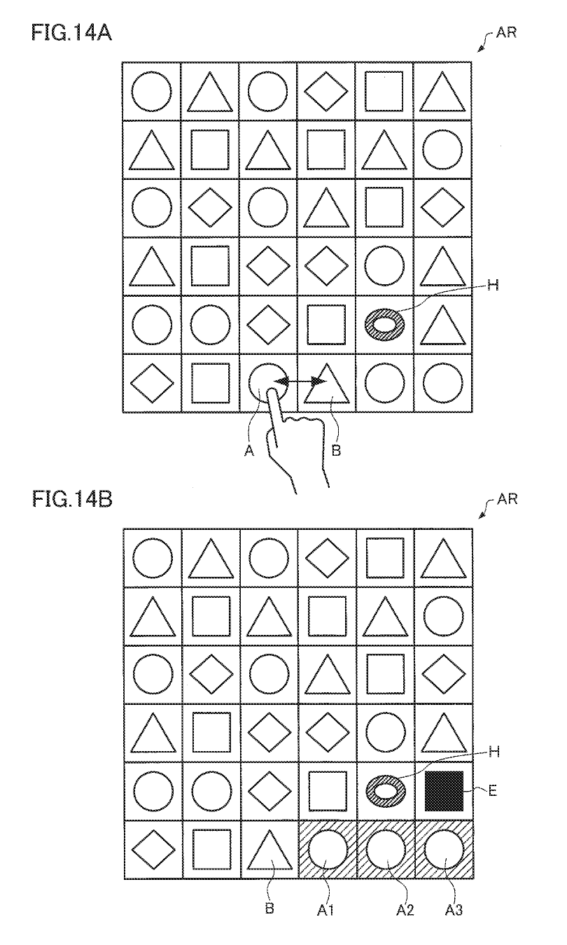

FIG. 14A illustrates an example in which the special object H is placed in the placement area AR in a fixed state. When the selection of the objects A and B that are placed in the lowermost row of the placement area AR has been received, the process that interchanges the objects A and B is performed (i.e., the placement state is changed). As illustrated in FIG. 14B, when three objects A1, A2, and A3 that have an identical attribute and are placed consecutively in the horizontal direction have been deleted from the placement area AR, a process that replaces an arbitrary object among the objects that are placed on the upper side, the lower side, the right side, or the left side of the special object H and adjoin the special object H with the special object E (i.e., a process that generates the special object E), is performed.

Specifically, when the special object H has been placed in the placement area AR, the special object E is generated in each player's turn when the object A, B, C, or D is placed in a square that adjoins the special object H. Therefore, the player must perform a selection input so that the object A, B, C, or D placed in a square that adjoins the special object E, is deleted.

(5) Special Object that Belongs to Fifth Type

The special object I that belongs to a fifth type is described below. The special object I is characterized in that (a) the special parameter DP of the special object I is decremented by 1 when the object (normal object) A, B, C, or D that has been placed on the special object I has been deleted.

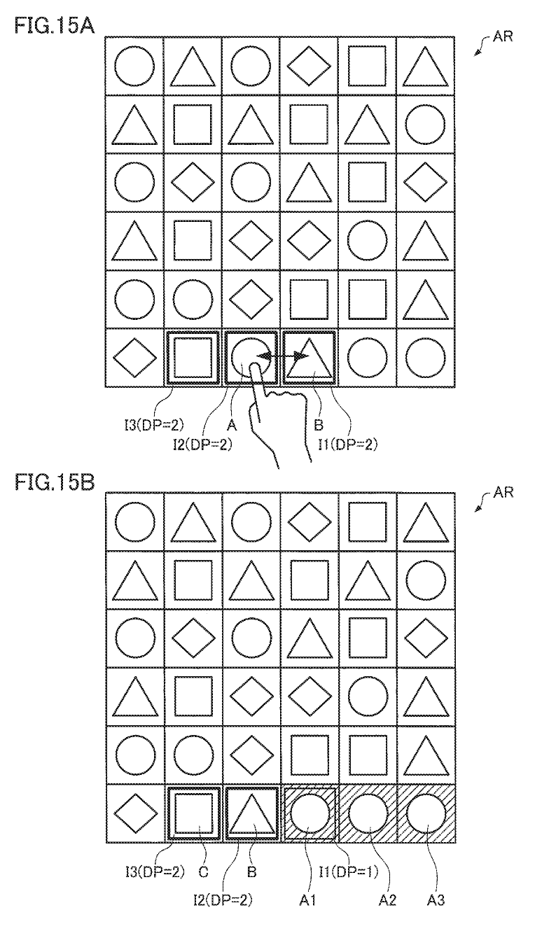

FIG. 15A illustrates an example in which special objects I1 (DP=2), I2 (DP=2), and I3 (DP=2) are placed in the placement area AR in a fixed state. In this embodiment, the display pattern of the special object I is changed based on the value of the special parameter DP of the special object I. For example, the special object I is displayed using a square drawn with a thick line when DP=2, and displayed using a square drawn with a thin line when DP=1. The special object I and the object (normal object) A, B, C, or D are displayed to overlap each other.

As illustrated in FIG. 15A, when the selection of the objects A and B that are placed in the lowermost row of the placement area AR has been received, the process that interchanges the objects A and B is performed (i.e., the placement state is changed).

As illustrated in FIG. 15B, three objects A1, A2, and A3 that have an identical attribute (identical color) are thus placed consecutively in the horizontal direction, and the process that deletes the objects A1, A2, and A3 from the placement area AR is performed. Since the object Al that is placed in the square in which the special object I1 is placed is deleted, a process that decrements the value of the special parameter DP of the special object I1 by 1 is performed. Specifically, the special parameter DP of the special object I1 decreases to 1. Since the object B that is placed in the square in which the special object I2 is placed, and the object C that is placed in the square in which the special object I3 is placed, are not deleted, the special parameter DP (DP=2) of the special object I2 and the special parameter DP (DP=2) of the special object I3 are maintained.

For example, when the stage clear condition is a condition whereby all of the special objects I have been deleted, the player must steadily decrease the special parameter DP of the special object I to 0 so that the special object I is deleted.

3.4 Process that Sets Card to Deck

In this embodiment, the difficulty level of the game is increased by utilizing the special objects that have an effect of hindering the player from deleting the objects during the game. However, it may be difficult for the player to clear the game if the effect of the special objects is too much. The player may lose his/her motivation to play the game if a situation in which the player cannot clear the game continues.

In this embodiment, a process that sets a card (i.e., game medium) to a deck (a predetermined area in the game space), and reduces the effect of the special object based on information about the deck, is performed in order to motivate the player to continue to play the game.

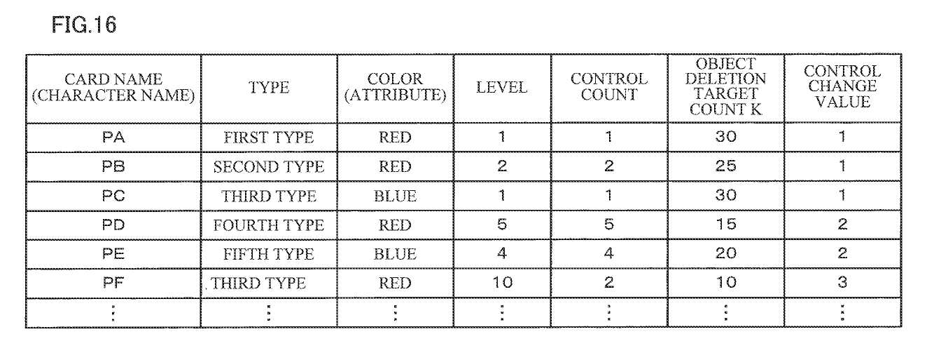

FIG. 16 illustrates an example of card information stored in the storage section of the terminal or the server. For example, parameters such as a type, a color (i.e., attribute), a level, a reduction count, an object deletion target count K, and a reduction value are stored in the storage section so as to be linked to identification information (e.g., card name) about each game medium (card).

The type represents the type of the reduction target special object. The color is an example of the attribute. The level is a value that increases corresponding to the clear count as a result of setting the card to the deck. The reduction count and the reduction width increase, and the object deletion target count K decreases as the level increases.

The reduction count is the number of times (turn count) in which the reduction effect occurs.

The object deletion target count K is a reduction condition. Specifically, the effect of a special object is reduced based on the card information when the number of objects that have been deleted within the placement area AR or a specific area within the placement area AR has reached the object deletion target count K.

3.5 Process that Reduces Special Effect of Special Object

In this embodiment, a process that reduces the special effect based on the information about each card set to a deck DE is performed. For example, when the type of the card set to the deck DE is a first type, a process that reduces the special effect of the special object E that belongs to the first type is performed. Specifically, a process that reduces the special effect of the special object that belongs to the same type as the card set to the deck DE is performed.

In this embodiment, a process that reduces the special effect of the special object placed within an area that corresponds to the set position of the card is performed.

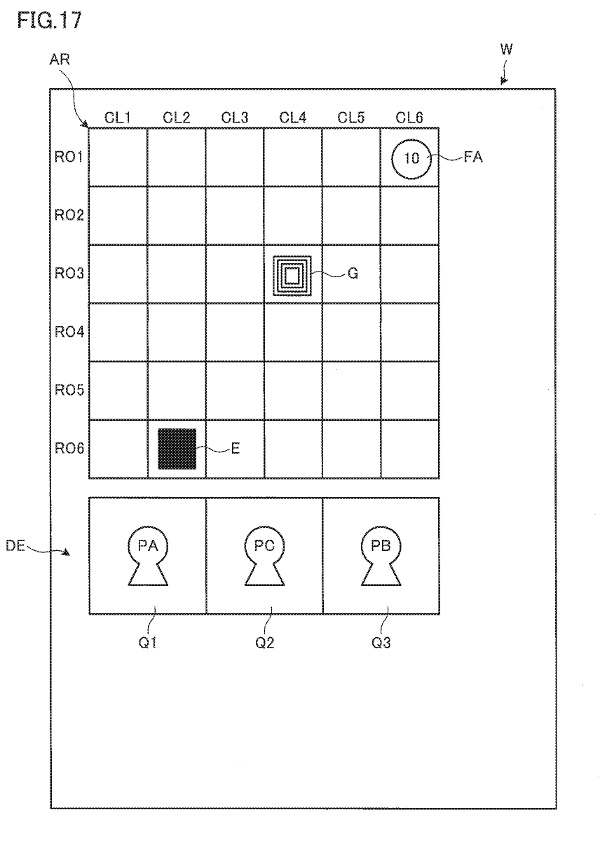

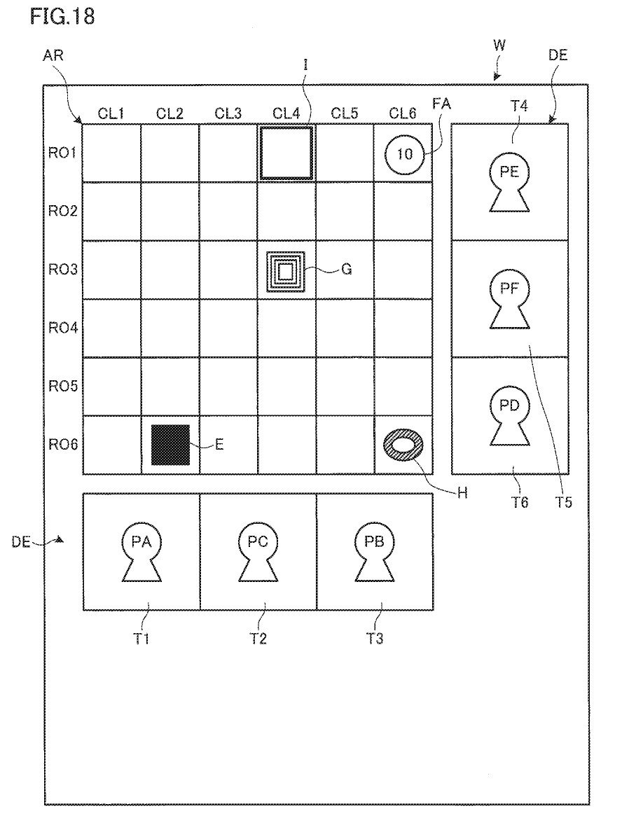

FIG. 17 illustrates an example of a game screen in which the card is set to the deck DE. FIG. 17 illustrates an example in which three cards can be set to the deck DE. The set position of each card is linked to a specific area of the placement area AR.

As illustrated in FIG. 17, the set position Q1 of a card PA is linked to columns CL1 and CL2 of the placement area AR, the set position Q2 of a card PC is linked to columns CL3 and CL4 of the placement area AR, and the set position Q3 of a card PB is linked to columns CL5 and CL6 of the placement area AR, for example.

Specifically, the card PA reduces the special effect of the special object that is placed in the column CL1 or CL2 of the placement area AR. Likewise, the card PC reduces the special effect of the special object that is placed in the column CL3 or CL4 of the placement area AR, and the card PB reduces the special effect of the special object that is placed in the column CL5 or CL6 of the placement area AR.

FIG. 18 illustrates an example in which six cards can be set to the deck DE. The set position of each card is linked to a specific area of the placement area AR.

As illustrated in FIG. 18, the set position T1 of a card PA is linked to columns CL1 and CL2 of the placement area AR, the set position T2 of a card PC is linked to columns CL3 and CL4 of the placement area AR, the set position T3 of a card PB is linked to columns CL5 and CL6 of the placement area AR, the set position T4 of a card PE is linked to rows RO1 and RO2 of the placement area AR, the set position T5 of a card PF is linked to rows RO3 and RO4 of the placement area AR, and the set position T6 of a card PD is linked to rows RO5 and RO6 of the placement area AR, for example.

Specifically, the card PA reduces the special effect of the special object that is placed in the column CL1 or CL2 of the placement area AR. Likewise, the card PC reduces the special effect of the special object that is placed in the column CL3 or CL4 of the placement area AR, and the card PB reduces the special effect of the special object that is placed in the column CL5 or CL6 of the placement area AR.

The card PE (that is set to the set position T4) reduces the special effect of the special object that is placed in the row RO1 or RO2 of the placement area AR. Likewise, the card PF (that is set to the set position T5) reduces the special effect of the special object that is placed in the row RO3 or RO4 of the placement area AR, and the card PD (that is set to the set position T6) reduces the special effect of the special object that is placed in the row RO5 or RO6 of the placement area AR.

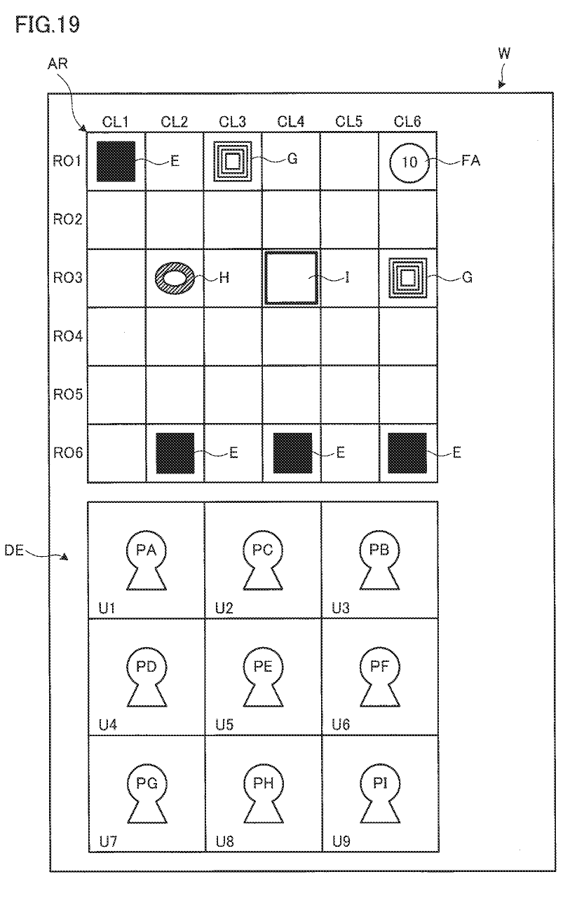

FIG. 19 illustrates an example in which nine cards can be set to the deck DE. The set position of each card is linked to a specific area of the placement area AR.

As illustrated in FIG. 19, the set position U1 of a card PA is linked to a 4-square area that corresponds to the columns CL1 and CL2 and the rows RO1 and RO2 of the placement area AR, the set position U2 of a card PC is linked to a 4-square area that corresponds to the columns CL3 and CL4 and the rows RO1 and RO2 of the placement area AR, and the set position U3 of a card PB is linked to a 4-square area that corresponds to the columns CL5 and CL6 and the rows RO1 and RO2 of the placement area AR, for example.

The set position U4 of a card PD is linked to a 4-square area that corresponds to the columns CL1 and CL2 and the rows RO3 and RO4 of the placement area AR, the set position U5 of a card PE is linked to a 4-square area that corresponds to the columns CL3 and CL4 and the rows RO3 and RO4 of the placement area AR, and the set position U6 of a card PF is linked to a 4-square area that corresponds to the columns CL5 and CL6 and the rows RO3 and RO4 of the placement area AR.

The set position U7 of a card PG is linked to a 4-square area that corresponds to the columns CL1 and CL2 and the rows RO5 and RO6 of the placement area AR, the set position U8 of a card PH is linked to a 4-square area that corresponds to the columns CL3 and CL4 and the rows RO5 and RO6 of the placement area AR, and the set position U9 of a card PI is linked to a 4-square area that corresponds to the columns CL5 and CL6 and the rows RO5 and RO6 of the placement area AR.

Specifically, the card PA reduces the special effect of the special object that is placed within a 4-square area that corresponds to the columns CL1 and CL2 and the rows RO1 and RO2 of the placement area AR. Likewise, the card PC reduces the special effect of the special object that is placed within a 4-square area that corresponds to the columns CL3 and CL4 and the rows RO1 and RO2 of the placement area AR, and the card PB reduces the special effect of the special object that is placed within a 4-square area that corresponds to the columns CL5 and CL6 and the rows RO1 and RO2 of the placement area AR.

The card PD reduces the special effect of the special object that is placed within a 4-square area that corresponds to the columns CL1 and CL2 and the rows RO3 and RO4 of the placement area AR. Likewise, the card PE reduces the special effect of the special object that is placed within a 4-square area that corresponds to the columns CL3 and CL4 and the rows RO3 and RO4 of the placement area AR, and the card PF reduces the special effect of the special object that is placed within a 4-square area that corresponds to the columns CL5 and CL6 and the rows RO3 and RO4 of the placement area AR.

The card PG reduces the special effect of the special object that is placed within a 4-square area that corresponds to the columns CL1 and CL2 and the rows RO5 and RO6 of the placement area AR. Likewise, the card PH reduces the special effect of the special object that is placed within a 4-square area that corresponds to the columns CL3 and CL4 and the rows RO5 and RO6 of the placement area AR, and the card PI reduces the special effect of the special object that is placed within a 4-square area that corresponds to the columns CL5 and CL6 and the rows RO5 and RO6 of the placement area AR.

In this embodiment, the special effect may be reduced when the object placed within an area that corresponds to the set position of the card has satisfied the predetermined condition, and has been deleted.

As illustrated in FIG. 17, the area that corresponds to the set position Q1 of the card PA corresponds to the columns CL1 and CL2 of the placement area AR, for example. In this case, a process of reducing the special effect of the special object E that is placed in the column CL2 and belongs to the same type as the card PA is performed when at least one of the objects (A, B, C, D) placed in the columns CL1 and CL2 of the placement area AR has been deleted.

In this embodiment, a process of reducing the special effect of the special object E that is placed in the column CL1 or CL2 of the placement area AR may be performed when the attribute of the card and the attribute of the object that is deleted (since the predetermined condition has been satisfied) have a predetermined relationship (e.g., are identical).

In the example illustrated in FIG. 17, since the attribute of the card PA is “red”, a process of reducing the special effect of the special object E that is placed in the column CL2 may be performed when at least one of the objects that are placed in the columns CL1 and CL2 of the placement area AR and are deleted is the object A that has the attribute “red”.

3.6 Specific Examples of Process that Reduces Special Effect of Special Object

The process that reduces the special effect of the special object is described in detail below. An example in which the card is set to the set position Q3 of the deck DE that corresponds to the columns CL5 and CL6 is described below for convenience of explanation.

(1) Specific Example of Process that Reduces Special Effect of Special Object E that Belongs to First Type

When the special object E is placed in the placement area AR in a fixed state, and the card PA that belongs to the first type (i.e., reduces the special effect of the special object that belongs to the first type) is not set to the deck DE, the process that generates an additional special object E is performed when the objects that are placed on the upper side, the lower side, the right side, or the left side of the special object E and adjoin the special object E are not deleted (see FIGS. 9A and 9B).

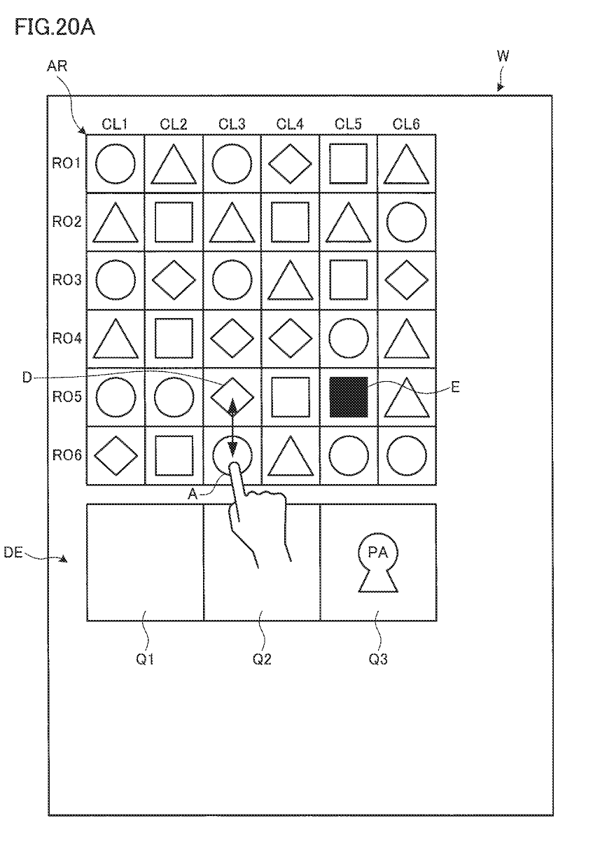

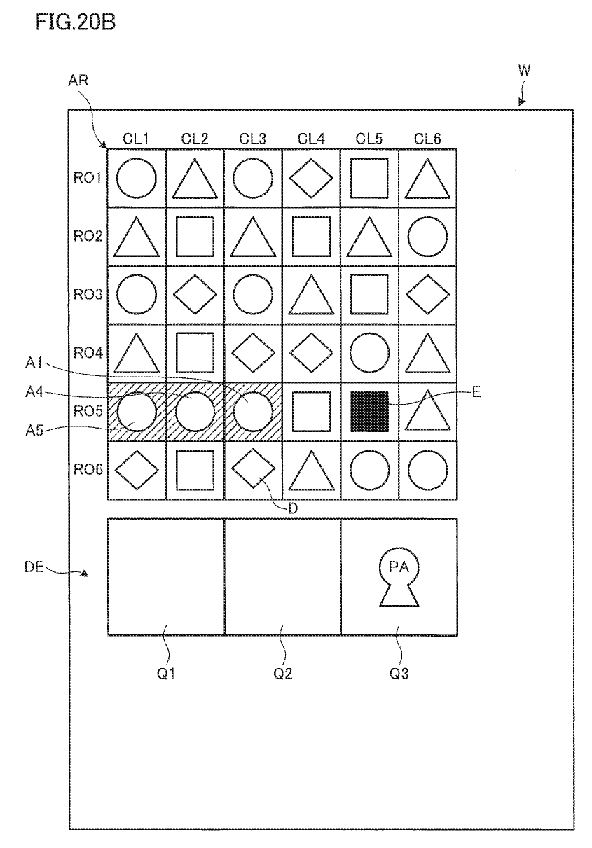

However, when the card PA that belongs to the first type (i.e., reduces the special effect of the special object that belongs to the first type) has been set to the deck DE (see FIG. 20A), a process (reduction process) that prevents the generation of an additional special object E is performed (see FIG. 20B).

In this embodiment, whether or not to perform the reduction process is determined based on the object deletion target count K that is set to the card. For example, when determining whether or not to perform the reduction process based on the card PA (object deletion target count=30), the number of objects (A to D) that are placed in the columns CL5 and CL6 (that correspond to the card PA) and have been deleted is counted, and the process that prevents the generation of an additional special object E is performed when the number of objects that have been deleted has reached 30. The counter value is returned to the initial value (0) when the reduction process has been performed.

In this embodiment, the number of times (turn count) in which the reduction process is performed is determined based on the reduction count set to the card. For example, the reduction count set to the card PA is 1. In this case, the generation of an additional special object E is controlled once (one turn).

In this embodiment, the reduction process is performed based on the reduction value. For example, since one additional special object E is generated in one turn when an object among the objects that adjoin the special object E is not deleted, the generation of one additional special object E is basically prevented. When two or more additional special objects E are generated in one turn when an object among the objects that adjoin the special object E is not deleted, the number of special objects E to be generated is limited based on the reduction value set to the card PA. For example, when three additional special objects E are generated in one turn, and the reduction value is “2”, the generation of two additional special objects E is prevented (i.e., one additional special object E is generated).

According to this configuration, the player can advantageously play the game by placing the card PA that has an effect of reducing the special object E that belongs to the first type in the deck. This makes it possible to motivate the player to play the game.

(2) Specific Example of Process that Reduces Special Effect of Special Objects FA to FD that Belong to Second Type

When the special object FA is placed in the placement area AR, and the card PB that belongs to the second type (i.e., reduces the special effect of the special object that belongs to the second type) is not set to the deck DE, the special parameter DP of the special object FA is decremented by 1 when the special object FA is not deleted (see FIGS. 11A and 11B).

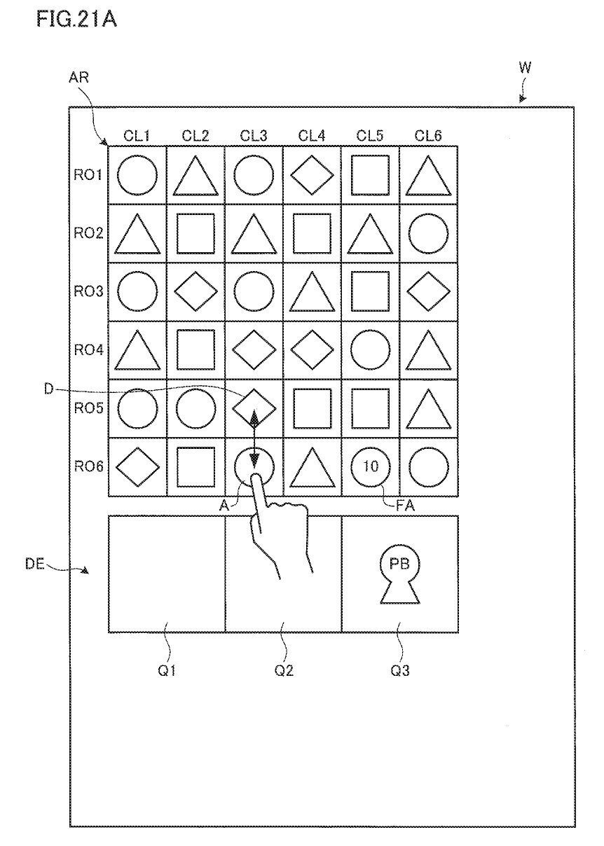

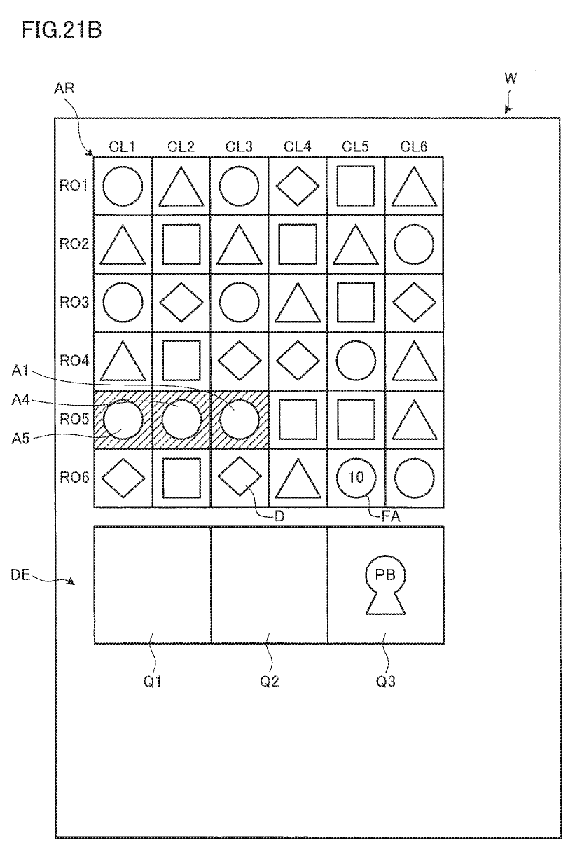

However, when the card PB that belongs to the second type (i.e., reduces the special effect of the special object that belongs to the second type) has been set to the deck DE (see FIG. 21A), a process (reduction process) that prevents the decrement of the special parameter DP of the special object FA even when the special object FA is not deleted is performed (see FIG. 21B).

For example, when determining whether or not to perform the reduction process based on the card PB (object deletion target count K=25), the number of objects (A to D) that are placed in the columns CL5 and CL6 (that correspond to the card PB) and have been deleted is counted, and the process that prevents the decrement of the special parameter DP of the special object FA is performed when the number of objects that have been deleted has reached 25. The counter value is returned to the initial value (0) when the reduction process has been performed. The number of objects that have been deleted may be counted on condition that the attribute of the card PB and the attribute of the object that has been deleted coincide with each other.

In this embodiment, the number of times (turn count) in which the reduction process is performed is determined based on the reduction count set to the card. For example, the reduction count set to the card PB is 2. In this case, the process that prevents the decrement of the special parameter DP of the special object FA is performed twice (two turns).

In this embodiment, the reduction process is performed based on the reduction value. For example, since the special parameter DP of the special object FA is decremented by 1 when the special object FA is not deleted, the process that prevents the decrement of the special parameter DP of the special object FA by 1 is basically performed as the reduction process. When the special parameter DP of the special object FA is decremented by 2 or more when the special object FA is not deleted, the decrement value is determined corresponding to the reduction value set to the card PB. For example, when the special parameter DP of the special object FA is decremented by 3 when the special object FA is not deleted, and the reduction value is “2”, the special parameter DP of the special object FA is decremented by 1.

Note that the reduction process may be performed on condition that the attribute of the card PB and the attribute of the special object that belongs to the second type coincide with each other.

According to this configuration, the player can advantageously play the game by placing the card PB that has an effect of reducing the special object FA that belongs to the second type in the deck. This makes it possible to motivate the player to play the game.

(3) Specific Example of Process that Reduces Special Effect of Special Object G that Belongs to Third Type

When the special object G is placed in the placement area AR in a fixed state, and the card PC that belongs to the third type (i.e., reduces the special effect of the special object that belongs to the third type) is not set to the deck DE, the process that prevents the decrement of the special parameter DP of the special object G is performed when the objects that are placed on the upper side, the lower side, the right side, or the left side of the special object G and adjoin the special object G are not deleted (see FIGS. 13A and 13B).

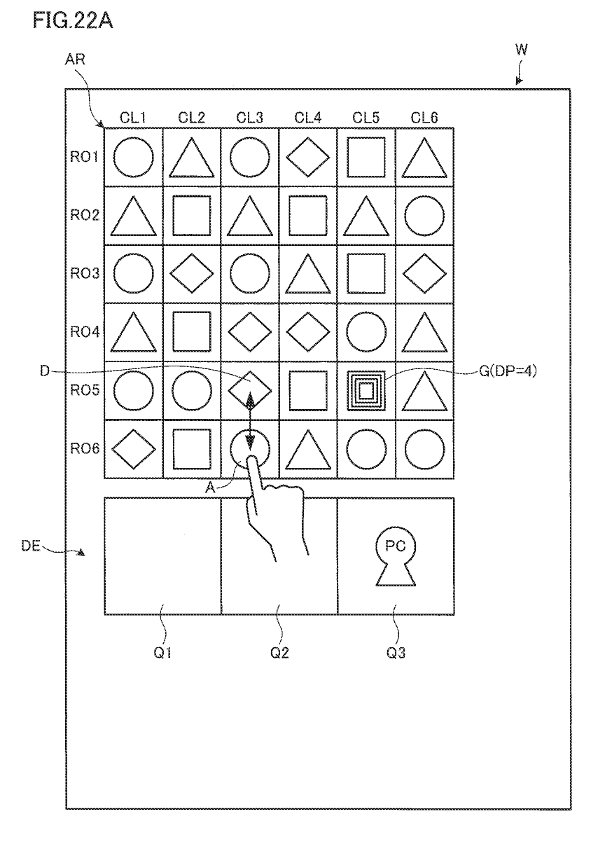

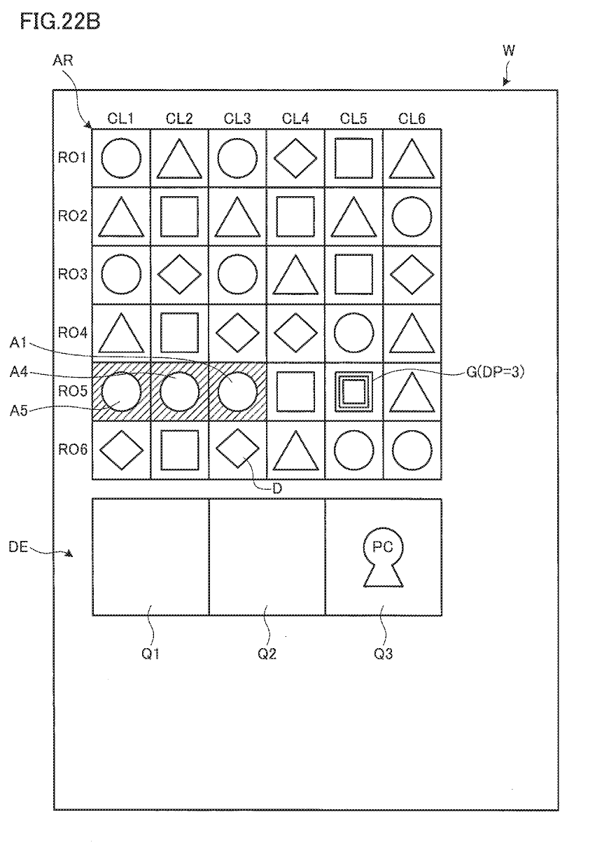

However, when the card PC that belongs to the third type (i.e., reduces the special effect of the special object that belongs to the third type) has been set to the deck DE (see FIG. 22A), a process (reduction process) that decrements the special parameter DP of the special object G is performed (see FIG. 22B).

For example, when determining whether or not to perform the reduction process based on the card PC (object deletion target count K=30), the number of objects (A to D) that are placed in the columns CL5 and CL6 (that correspond to the card PC) and have been deleted is counted, and the process that decrements the special parameter DP of the special object G is performed when the number of objects that have been deleted has reached 30. The counter value is returned to the initial value (0) when the reduction process has been performed.

In this embodiment, the number of times (turn count) in which the reduction process is performed is determined based on the reduction count set to the card. For example, the reduction count set to the card PC is 1. In this case, the process that decrements the special parameter DP of the special object G is performed once (one turn).

In this embodiment, the reduction process is performed based on the reduction value. For example, a process that subtracts the reduction value (e.g., 1) set to the card PC from the special parameter DP of the special object G is performed.

According to this configuration, the player can advantageously play the game by placing the card PC that has an effect of reducing the special object G that belongs to the third type in the deck. This makes it possible to motivate the player to play the game.

(4) Specific Example of Process that Reduces Special Effect of Special Object H that Belongs to Fourth Type

When the special object H is placed in the placement area AR in a fixed state, and the card PD that belongs to the fourth type (i.e., reduces the special effect of the special object that belongs to the fourth type) is not set to the deck DE, the process that generates the special object E in one of the squares that adjoin the special object H is performed (see FIGS. 14A and 14B).

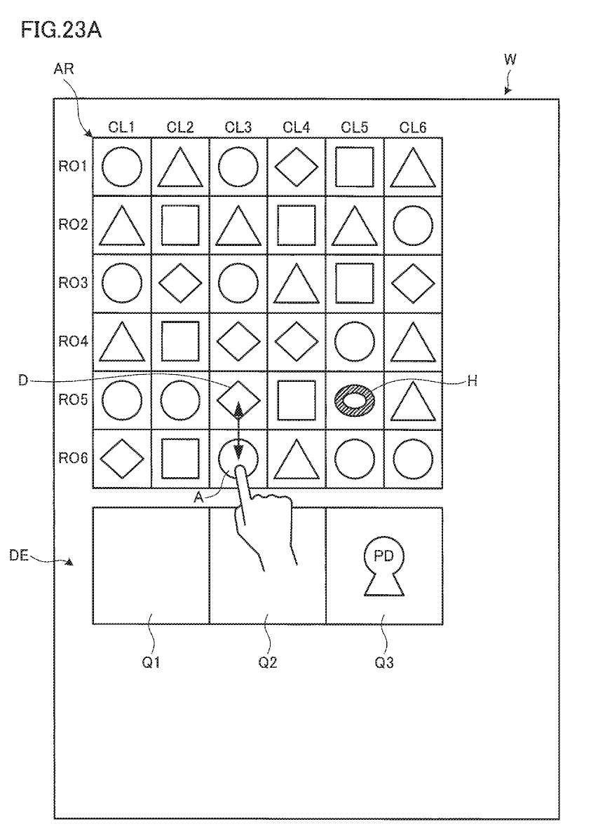

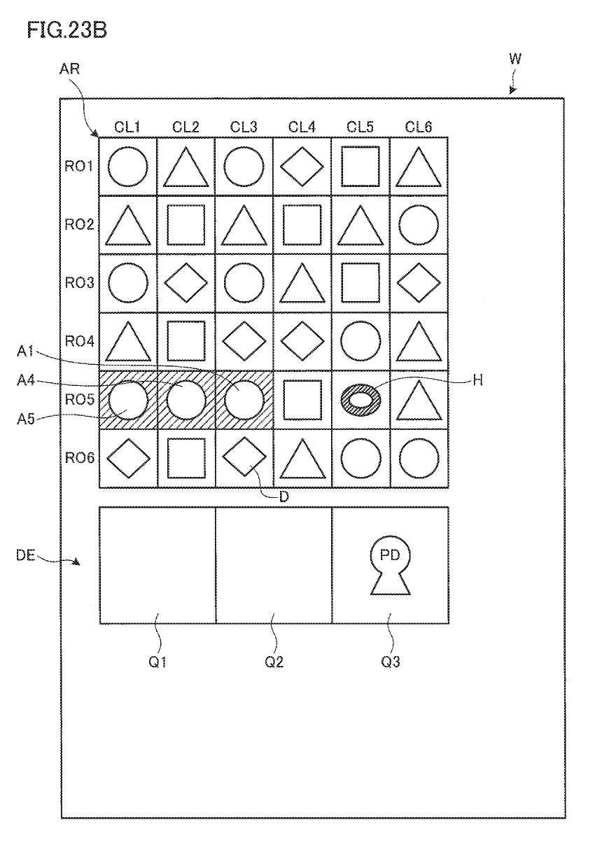

However, when the card PD that belongs to the fourth type (i.e., reduces the special effect of the special object that belongs to the fourth type) has been set to the deck DE (see FIG. 23A), a process (reduction process) that prevents the generation of the special object E is performed (see FIG. 23B).

For example, when determining whether or not to perform the reduction process based on the card PD (object deletion target count K=15), the number of objects (A to D) that are placed in the columns CL5 and CL6 (that correspond to the card PD) and have been deleted is counted, and the process that prevents the generation of the special object E is performed when the number of objects that have been deleted has reached 15. The counter value is returned to the initial value (0) when the reduction process has been performed.

The reduction count set to the card PA is 5. In this case, the generation of the special object E is prevented five times (five turns).

In this embodiment, the reduction process is performed based on the reduction value. For example, since one special object E is generated in one turn, the generation of one special object E is basically controlled. When two or more special objects E are generated in one turn, the number of special objects E to be generated is limited based on the reduction value set to the card PC. For example, when three special objects E are generated in one turn, and the reduction value is “2”, the generation of two special objects E is prevented (i.e., one special object E is generated).

According to this configuration, the player can advantageously play the game by placing the card PD that has an effect of reducing the special object H that belongs to the fourth type in the deck. This makes it possible to motivate the player to play the game.

(5) Specific Example of Process that Reduces Special Effect of Special Object I that Belongs to Fifth Type

When the special object I is placed in the placement area AR in a fixed state, and the card PE that belongs to the fifth type (i.e., reduces the special effect of the special object that belongs to the fifth type) is not set to the deck DE, the object B that is placed in the square in which the special object I2 is placed, and the object C that is placed in the square in which the special object I3 is placed, are not deleted, and the special parameter DP (DP=2) of the special object I2 and the special parameter DP (DP=2) of the special object I3 are maintained (see FIGS. 15A and 15B).

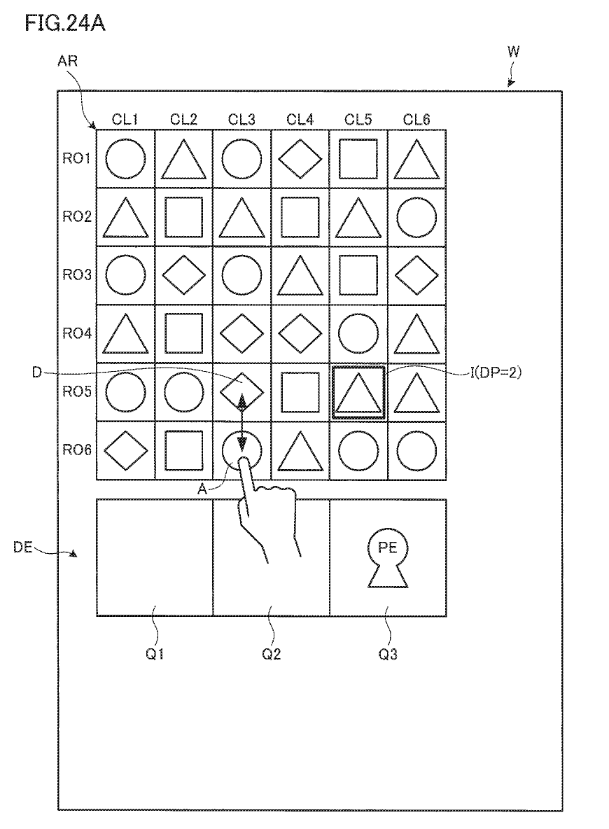

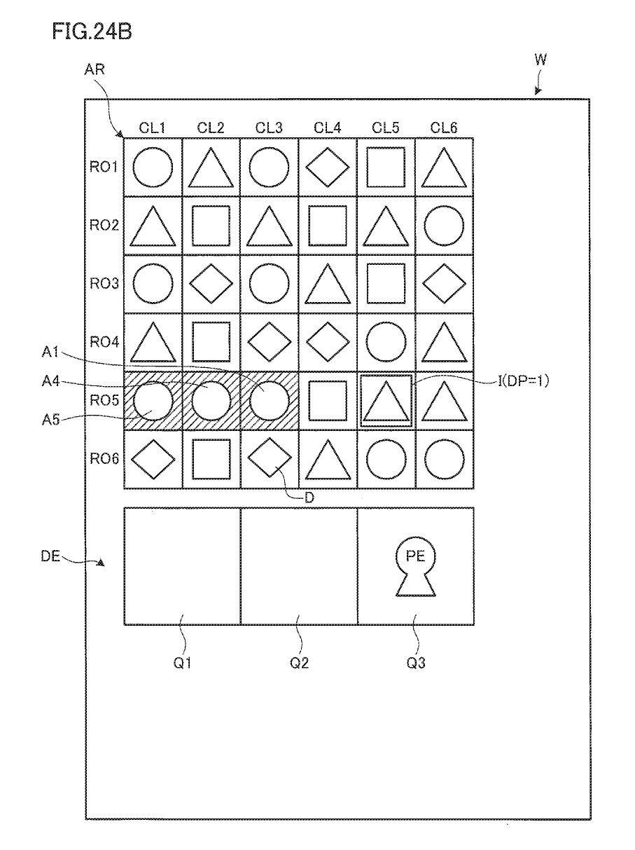

However, when the card PE that belongs to the fifth type (i.e., reduces the special effect of the special object that belongs to the fifth type) has been set to the deck DE (see FIG. 24A), a process (reduction process) that decrements the special parameter DP of the special object I is performed (see FIG. 24B).

For example, when determining whether or not to perform the reduction process based on the card PE (object deletion target count K=20), the number of objects (A to D) that are placed in the columns CL5 and CL6 (that correspond to the card PE) and have been deleted is counted, and the process that decrements the special parameter DP of the special object I is performed when the number of objects that have been deleted has reached 20. The counter value is returned to the initial value (0) when the reduction process has been performed.

In this embodiment, the number of times (turn count) in which the reduction process is performed is determined based on the reduction count set to the card. For example, the reduction count set to the card PE is 4. In this case, the process that decrements the special parameter DP of the special object I is performed four times (four turns).

In this embodiment, the reduction process is performed based on the reduction value. For example, a process that subtracts the reduction value (e.g., 2) set to the card PE from the special parameter DP of the special object I is performed.

According to this configuration, the player can advantageously play the game by placing the card PE that has an effect of reducing the special object I that belongs to the fifth type in the deck. This makes it possible to motivate the player to play the game.

### 3.7 Presentation Information

In this embodiment, at least one of the information about the shape of the placement area that corresponds to each stage, and the information about the special object that is placed in the placement area (e.g., information about the position and the type of the special object placed in the placement area), is displayed as the presentation information before the card is set to the deck DE. According to this configuration, the player can set an optimum card to the deck DE by referring to the type and the position of the special object. Note that the attribute (color) of the special objects FA to FB that belong to the second type may or may not be displayed.

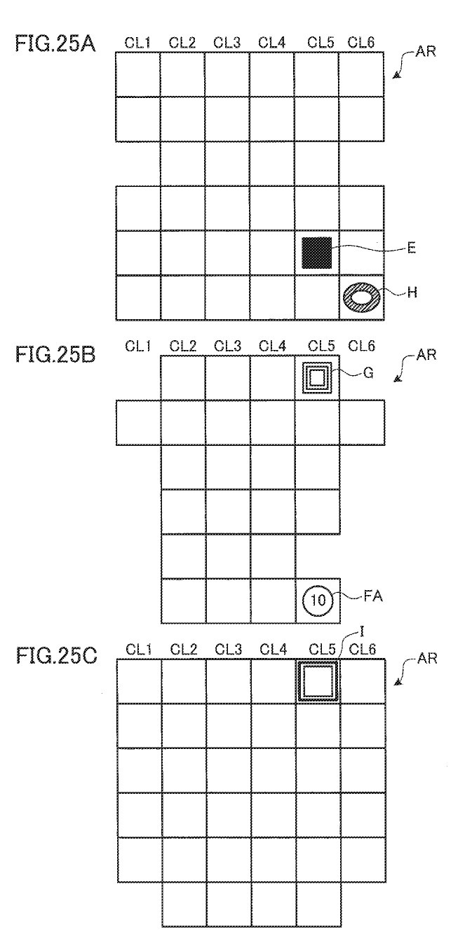

For example, FIGS. 25A to 25C illustrate the placement area AR that corresponds to each stage, and an example of the placement of the special object. Specifically, the shape of the placement area AR is determined in advance on a stage basis. When the placement area AR has a square shape that consists of 6×6 squares (36 squares in total), the player can easily place the objects that have an identical attribute in the vertical direction and the horizontal direction. However, when the placement area AR has a shape in which some of the squares are omitted (see FIGS. 25A to 25C), it is difficult for the player to place the objects that have an identical attribute in the vertical direction or the horizontal direction in an area that adjoins the omission area.

As illustrated in FIGS. 25A to 25C, a different special object is placed on a stage basis. The player selects a card that belongs to the same type as the type of the special object represented by the presentation information, and sets the selected card to the set position at which it is possible to reduce the special effect of the special object.

In the example illustrated in FIG. 25A, the player sets the card PA that can reduce the special effect of the special object E in the deck DE to the set position that corresponds to the columns CL5 and CL6. Alternatively, the player sets the card PD that can reduce the special effect of the special object H in the deck DE to the set position that corresponds to the columns CL5 and CL6.

In the example illustrated in FIG. 25B, the player sets the card PB that can reduce the special effect of the special object FA in the deck DE to the set position that corresponds to the columns CL5 and CL6. Alternatively, the player sets the card PC that can reduce the special effect of the special object G in the deck DE to the set position that corresponds to the columns CL5 and CL6.

In the example illustrated in FIG. 25C, the player sets the card PE that can reduce the special effect of the special object I in the deck DE to the set position that corresponds to the columns CL5 and CL6.

In this embodiment, the presentation information may be displayed corresponding to a stage for which the play count is equal to or larger than a predetermined value (e.g., 1), and the clear condition has not been satisfied. Specifically, since the presentation information is information that is effective for the player to clear the stage, the presentation information may be provided to the player after the player has tried to clear the stage at least once, and failed to clear the stage a predetermined number of times or more. This makes it possible to further motivate the player to play the game.

### 3.8 Enhancement of Card (Game Medium)

In this embodiment, whether or not the clear condition set to each stage has been satisfied is determined. A process (enhancement process) that changes a predetermined parameter of the card set to the deck may be performed when the clear condition set to the stage has been satisfied. For example, when the clear condition set to the stage has been satisfied, the level, the reduction count, and the reduction value set to each card set to the deck are increased, and the object deletion target count K set to each card set to the deck is decreased.

In this embodiment, the degree of reduction of the special effect is changed corresponding to a predetermined parameter (e.g., level, reduction count, object deletion target count K, or reduction value) set to the card set to the deck. According to the above configuration, it is possible to prompt the player to play a stage with a low difficulty level or the stage that has been cleared in order to enhance (strengthen) the card.

### 3.9 Flowchart

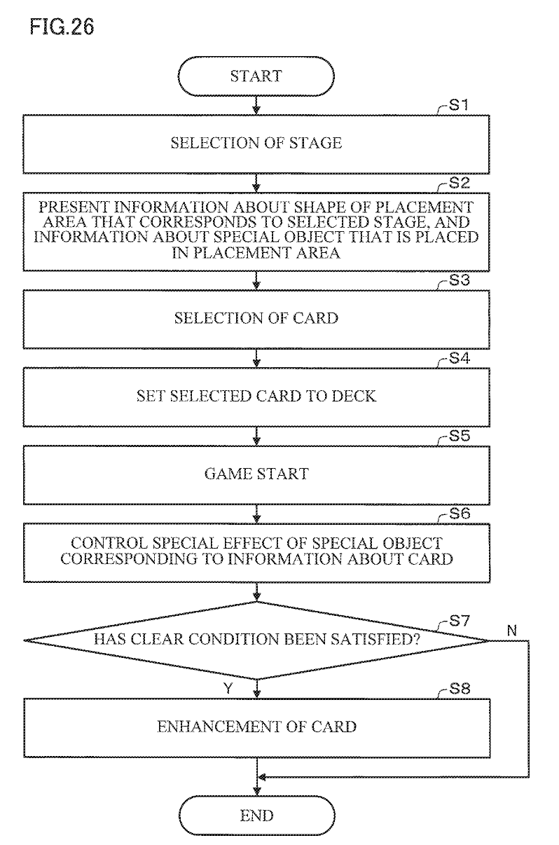

The flow of the process according to one embodiment of the invention is described below with reference to FIG. 26.

The process that receives the selection of the stage based on the input information input by the player is performed (step S1). The process that presents (displays) the information about the shape of the placement area that corresponds to the selected stage, and the information (e.g., position and type) about the special object that is placed in the placement area, is performed (step S2).

The selection of the card that is set to the deck is received based on the input information input by the player (step S3). The process that sets the card selected based on the input information input by the player to the deck is performed (step S4).

When the game has started (step S5), the process that reduces the special effect of the special object based on the information about the card is performed (step S6).

Whether or not the clear condition has been satisfied is determined (step S7). When the clear condition has been satisfied (Y in step S7), the process that enhances the card is performed (step S8), and the process is terminated. When the clear condition has not been satisfied (N in step S7), the process is terminated.

### 3.10 Other

Although an example in which the area in which the reduction effect is produced based on the information about the card is limited to the area within the placement area AR that corresponds to the set position of the card has been described above, the area in which the reduction effect is produced based on the information about the card may be set to the entire placement area AR.

The special object H that belongs to the fourth type basically cannot be deleted. Note that the special object H that belongs to the fourth type may be deleted when a card that satisfies a predetermined condition has been set to the deck.

For example, when a card that satisfies a predetermined condition (e.g., a card that can delete the special object that belongs to the fourth type, or a card to which a level equal to or higher than 50 is set) has been set to the set position T3 of the deck DE in a state in which the special object H is placed in the placement area AR (see FIG. 18), the number of objects (A to D) that are placed in the columns CL5 and CL6 (that correspond to the card) and have been deleted may be counted, and the special object H may be deleted when the number of objects that have been deleted has reached the object deletion target count K set to the card.

### 4. Application Example

The invention is not limited to the above embodiments. Various modifications and variations may be made of the above embodiments. Any term cited with a different term having a broader meaning or the same meaning at least once in the specification and the drawings may be replaced by the different term in any place in the specification and the drawings.

### Application Example of Game System

Although an example of the process performed by the terminal has been described above, the server 20 may perform part of the process performed by the processing section 100 included in the terminal 10.

The game system according to the embodiments of the invention may have a configuration in which the server 20 implements almost all of the functions of the processing section 100 included in the terminal 10.

For example, the game system may be a system that is implemented by cloud computing. When utilizing cloud computing, the server stores, manages, and processes the information (e.g., player information) about each player. Specifically, the terminal 10 transmits the input information from the input section 160 to the server 20. The server 20 performs the process of each section of the processing section 100 to generate image generation data for generating an image, and transmits the generated image generation data to each terminal. Note that the term “image generation data” used herein refers to data for displaying an image generated by the method according to the embodiments of the invention on each terminal. The image generation data may be image data, or may be data (e.g., object data and game processing result data) that is used when each terminal generates an image. The game system may be configured so that the server and the terminal implement the process of each section of the processing section 100 in a distributed manner.

Although only some embodiments of the invention have been described in detail above, those skilled in the art would readily appreciate that many modifications are possible in the embodiments without materially departing from the novel teachings and advantages of the invention. Accordingly, all such modifications are intended to be included within the scope of the invention.

What is claimed is:

1. A non-transitory computer-readable information storage medium storing a program that performs a process of causing a game to advance by receiving selection of an object among a plurality of objects placed in a placement area based on input information input by a player, changing a placement state of the selected object, and deleting the object that satisfies a predetermined condition, the program causing a computer to function as:
an object control section that places the objects and a special object that affects progress of a game in the placement area;
a special effect control section that performs a process that generates a special effect of the special object and a process that reduces the special effect of the special object; and
a deck setting section that sets a game medium that has been selected based on the input information input by the player to a deck prior to start of the game,
wherein the special effect control section performs the process that reduces the special effect based on information about the game medium set to the deck.

2. The information storage medium as defined in claim 1,
wherein the special effect control section reduces the special effect of the special object placed within an area that corresponds to a set position of the game medium.

3. The information storage medium as defined in claim 1,
wherein the program causes the computer to further function as:
a game processing section that performs the process of causing the game to advance on a stage basis based on information about a shape of the placement area that corresponds to each stage, and information about the special object that is placed in the placement area; and
a display control section that displays at least one of the information about the shape of the placement area that corresponds to each stage, and the information about the special object that is placed in the placement area, as presentation information before the game medium is set to the deck.

4. The information storage medium as defined in claim 3,
wherein the game processing section performs a process that counts a play count that corresponds to each stage, and determines whether or not a clear condition set to each stage has been satisfied, and
the display control section displays the presentation information corresponding to a stage for which the play count is equal to or larger than a predetermined value, and the clear condition has not been satisfied.

5. The information storage medium as defined in claim 1,
wherein the special effect control section reduces the special effect when part of the objects placed within an area that corresponds to a set position of the game medium satisfies the predetermined condition.

6. The information storage medium as defined in claim 1,
wherein the special effect control section reduces the special effect when an attribute of the game medium and an attribute of part of the objects that satisfies the predetermined condition have a predetermined relationship.

7. The information storage medium as defined in claim 1,
wherein the special effect control section reduces the special effect when the number of part of the objects that satisfy the predetermined condition is equal to or larger than a predetermined value.

8. The information storage medium as defined in claim 1,
wherein the program causes the computer to further function as:
a game processing section that performs a process of determining whether or not a clear condition has been satisfied on a stage basis; and
a parameter control section that performs a process that changes a predetermined parameter of the game medium set to the deck when the clear condition has been satisfied, and
wherein the special effect control section changes a degree of reduction of the special effect based on the predetermined parameter of the game medium set to the deck.

9. A terminal that performs a process of causing a game to advance by receiving selection of an object among a plurality of objects placed in a placement area based on input information input by a player, changing a placement state of the selected object, and deleting the object that satisfies a predetermined condition, the terminal comprising:
an object control section that places the objects and a special object that affects progress of a game in the placement area;
a special effect control section that performs a process that generates a special effect of the special object and a process that reduces the special effect of the special object; and
a deck setting section that sets a game medium that has been selected based on the input information input by the player to a deck prior to start of the game,
wherein the special effect control section performs the process that reduces the special effect based on information about the game medium set to the deck.

10. A server that performs a process of causing a game to advance by receiving selection of an object among a plurality of objects placed in a placement area based on input information input by a player, changing a placement state of the selected object, and deleting the object that satisfies a predetermined condition, the server comprising:
an object control section that places the objects and a special object that affects progress of a game in the placement area;
a special effect control section that performs a process that generates a special effect of the special object and a process that reduces the special effect of the special object; and
a deck setting section that sets a game medium that has been selected based on the input information input by the player to a deck prior to start of the game,
wherein the special effect control section performs the process that reduces the special effect based on information about the game medium set to the deck.
